(19) United States
(12) Patent Application Publication
(10) Pub. No.: US 2003/0175004 A1
(43) Pub. Date: Sep. 18, 2003

(54) Optical polymer nanocomposites

(76) Inventors: Anthony F. Garito, Radnor, PA (US); Yu-Ling Hsiao, Collegeville, PA (US); Renyuan Gao, Wayne, PA (US); Jingsong Zhu, Phoenixville, PA (US); Brian Thomas, Exton, PA (US); Anna Panackal, Philadelphia, PA (US); Jaya Sharma, West Chester, PA (US); Renfeng Gao, Phoenixville, PA (US)

Correspondence Address: Finnegan, Henderson, Farabow,, Garrett & Dunner, L.L.P., 1300 I Street, N.W., Washington, DC, 20005-3315, US

(21) Appl. No.: 10/367,683

(22) Filed: Feb. 19, 2003

Related U.S. Application Data
(60) Provisional application No. 60/357,958, filed on Feb. 19, 2002.
(60) Provisional application No. 60/430,043, filed on Dec. 2, 2002.

(51) Int. Cl. G02B 6/00

(52) U.S. Cl. 385/143

(57) ABSTRACT

A composite material that includes a host matrix and a plurality of dispersed nanoparticles within the host matrix. Each of the plurality of nanoparticles may include a halogenated outer coating layer that seals the nanoparticle and prevents agglomeration of the nanoparticles within the host matrix. The invention also includes a process of forming the composite material. Depending on the nanoparticle material, the composite material may have various applications including, but not limited to, optical devices, windowpanes, mirrors, mirror panels, optical lenses, optical lens arrays, optical displays, liquid crystal displays, cathode ray tubes, optical filters, optical components, all these more generally referred to as components.

### CROSS-REFERENCE TO RELATED APPLICATIONS

This application claims the benefit of priory under 35 U.S.C. § 119(e) to U.S. Provisional Application 60/357,958 filed Feb. 19, 2002, and U.S. Provisional Application 60/430,043 filed Dec. 2, 2002, both of which are herein incorporated by reference.

### FIELD OF THE INVENTION

The present invention relates to composite materials, such as polymer nanocomposites. The polymer nanocomposites according to the present invention comprise a host matrix and a plurality of nanoparticles within the host matrix. BACKGROUND

Composite materials are well known, and generally comprise two or more materials each offering its own set of properties or characteristics. The two or more materials may be joined together to form a system that exhibits properties derived from each of the materials. A common form of a composite is one with a body of a first material (a host matrix) with a second material distributed in the host matrix.

One class of composite materials includes nanoparticles distributed within a host matrix material. Nanoparticles are particles of a material that have a size measured on a nanometer scale. Generally, nanoparticles are larger than a cluster (which might be only a few hundred atoms in some cases), but with a relatively large surface area-to-bulk volume ratio. While most nanoparticles have a size from about 10 nm to about 500 nm, the term nanoparticles can cover particles having sizes that fall outside of this range. For example, particles having a size as small as about 1 nm and as large as about 1×10³ nm could still be considered nanoparticles. Nanoparticles can be made from a wide array of materials. Among these materials examples include, transition metals, rare-earth metals, group VA elements, polymers, dyes, semiconductors, alkaline earth metals, alkali metals, group IIIA elements, and group IVA elements.

Further, nanoparticles themselves may be considered a nanoparticle composite, which may comprise a wide array of materials, single elements, mixtures of elements, stoichiometric or non-stoichiometric compounds. The materials may be crystalline, amorphous, or mixtures, or combinations of such structures.

The host matrix may comprise a random glassy matrix such an amorphous organic polymer. Organic polymers may include typical hydrocarbon polymers and halogenated polymers. It is generally desirable that in an optical component, such as a planar optical waveguide, an optical fiber, an optical film, or a bulk optical component, e.g., an optical lens or prism, the total optical loss be kept at a minimum. For example, in the case of a planar optical wavegide, the total loss should be approximately equal to, or less than, 0.5 dB/cm in magnitude, and such as less than 0.2 dB/cm. For a highly transparent optical medium to be used as the optical material, a fundamental requirement is that the medium exhibits little, or no, absorption and scattering losses.

Intrinsic absorption losses commonly result from the presence of fundamental excitations that are electronic, vibrational, or coupled electronic-vibrational modes in origin. Further, the device operating wavelength of the optical component should remain largely different from the fundamental, or overtone, wavelengths for these excitations, especially in the case of the telecommunication wavelengths of 850, 1310, and 1550 nm located in the low loss optical window of a standard silica glass optical fiber, or waveguide. Further, these absorptive overtones can cause the hydrocarbon polymers to physically or chemically degrade, thereby leading to additional and often times permanent increase in signal attenuation in the optical fibers or waveguides

Material scattering losses occur when the signal wave encounters abrupt changes in refractive index of the otherwise homogeneous uniform optical medium. These discontinuities can result from the presence of composition inhomogenieties, crystallites, nanoporous structures, voids, fractures, stresses, faults, or even foreign impurities such as dust or other particulates.

Among the various mechanisms of optical scattering loss, an important factor is the porosity of the optical material. As a result of the interplay between various material characteristics, e.g., surface energy, solubility, glass transition temperature, entropy, etc., and processing conditions, e.g. temperature, pressure, atmosphere, etc., optical materials, such as amorphous perfluoropolymers can exhibit a large amount of nanoporous structures under normal processing conditions. Such nanoporous structures can cause optical scattering loss and should be eliminated, or converted to smaller sizes, in order to satisfy a certain low optical loss device performance requirement. The smaller sized pores are called nanopores. Nanopores are pores in a material that have a size measured on a nanometer scale. Generally, nanopores are larger than the size of an atom but smaller than 1000 nm. While most nanopores have a size from about 1 nm to about 500 nm, the term nanopores can cover pores having sizes that fall outside of this range. For example, pores having a size as small as about 0.5 nm and as large as about 1×10³ nm could still be considered nanopores

By introducing nanoparticles into optically transparent host matrix,the absorption and scattering losses due to the nanoparticles may add to the optical loss. In order to keep the optical loss to a minimum, in addition to controlling the loss contribution from the host matrix, it is essential to control the absorption and scattering loss from the nanoparticles doped into the host matrix for optical applications.

For discrete nanoparticles that are approximately spherical in shape and doped into the host matrix, the scattering loss α, in dB per unit length, resulting from the presence of the particles is dependent on the particle diameter d, the refractive index ratio of the nanoparticles and the waveguide core m=nₚₐᵣ/n_{core}, and the volume fraction of the nanoparticles in the host waveguide core Vₚ. The nanoparticle induced scattering loss can be calculated by:

$$α = 1.692 \times {10}^{3} {( \frac{{m}^{2} - 1}{{m}^{2} + 2} )}^{2} \frac{{d}^{3} {V}_{p}}{{λ}^{4}} , \qquad ( 1 )$$

where λ is the vacuum propagation wavelength of the light guided inside the waveguide. As an example, when m=2, Vₚ=10%, λ=1550 nm, d=10 nm, the calculated scattering loss a is 0.07 dB/cm. To fabricate a certain waveguide device with a set loss specification, and therefore a nanoparticle induced waveguide loss budget of α, the nanoparticle diameter d must satisfy the following equation relationships:

$$d < {( α \frac{1}{1.692 \times {10}^{3}} {( \frac{{m}^{2} + 2}{{m}^{2} - 1} )}^{2} \frac{{λ}^{4}}{{V}_{p}} )}^{1 / 3} , \qquad ( 2 )$$

where λ is the vacuum propagation wavelength of the light guided inside the waveguide, m=nₚₐᵣ/n_{core} the refractive index ratio of the nanoparticles and the core, and Vₚ the volume fraction of the nanoparticles in the host waveguide core. For example, following Equation 2, with a nanoparticle loss budget of α=0.5 dB/cm, when m=2, Vₚ=10%, λ=1550 nm, the nanoparticle diameter d must be smaller than 19 nm. In general, the diameter of the nanoparticles must be smaller than about 50 nm, and more preferably, 20 nm.

The description for nanoparticle loss also can be applied to nanopore contributions to propagation loss by representing the nanopores as equivalent nanoparticles with refractive index of 1.

Composite materials including nanoparticles distributed within a host matrix material have been used in optical applications. For example, U.S. Pat. No. 5,777,433 (the '433 patent) discloses a light emitting diode (LED) that includes a packaging material including a plurality of nanoparticles distributed within a host matrix material. The nanoparticles increase the index of refraction of the host matrix material to create a packaging material that is more compatible with the relatively high refractive index of the LED chip disposed within the packaging material. Because the nanoparticles do not interact with light passing through the packaging material, the packaging material remains substantially transparent to the light emitted from the LED.

While the packaging material used in the '433 patent offers some advantages derived from the nanoparticles distributed within the host matrix material, the composite material of the '433 patent remains problematic. For example, the composite material of the '433 patent includes glass or ordinary hydrocarbon polymers, such as epoxy and plastics, as the host matrix material. While these materials may be suitable in certain applications, they limit the capabilities of the composite material in many other areas. For example, the host matrix materials of the '433 patent commonly exhibit high absorption losses.

Moreover,the method of the '433 patent is problematic in not accounting for optical scattering loss from relatively large nanopores or nanoporous structures. In fact, among the various mechanisms of optical scattering loss, an important factor is the porosity of the optical material. As a result of the interplay between various material characteristics, e.g., surface energy, solubility, glass transition temperature, entropy, etc., and processing conditions, e.g. temperature, pressure, atmosphere, etc., optical materials, such as amorphous perfluoropolymers, can exhibit a large amount of nanoporous structures under normal processing conditions. Such nanoporous structures can cause optical scattering loss and should be eliminated, or converted to smaller sizes, in order to satisfy a certain low optical loss device performance requirement. By controlling the pore sizes and pore structures, optical scattering losses can be greatly reduced. The method of the '433 patent does not recognize the presence of discrete pores or porous structure nor teach control of their sizes and structures.

Additionally, the method of the '433 patent for dealing with agglomeration of the nanoparticles within the host matrix material is inadequate for many composite material systems. Agglomeration is a significant problem when making composite materials that include nanoparticles distributed within a host matrix material. Because of the small size and great numbers of nanoparticles that may be distributed within a host matrix material, there is a large amount of interfacial surface area between the surfaces of the nanoparticles and the surrounding host matrix material. As a result, the nanoparticle/host-matrix material system operates to minimize this interfacial surface area, and corresponding surface energy, by combining the nanoparticles together to form larger particles. This process is known as agglomeration. Once the nanoparticles have agglomerated within a host matrix material, it is extremely difficult to separate the agglomerated particles back into individual nanoparticles.

Agglomeration of the nanoparticles within the host matrix material may result in a composite material that lacks a desired characteristic. Specifically, when nanoparticles agglomerate together, the larger particles formed may not behave in a similar way to the smaller nanoparticles. For example, while nanoparticles may be small enough to avoid scattering light within the composite material, agglomerated particles may be sufficiently large to cause scattering. As a result, a host matrix material may become substantially less transparent in the presence of such agglomerated particles.

To combat agglomeration, the composite material of the '433 patent includes an anti-flocculant coating disposed on the nanoparticles intended to inhibit agglomeration. Specifically, the '433 patent suggests using surfactant organic coatings to suppress agglomeration. These types of coatings, however, may be inadequate or ineffective especially when used with host matrix materials other than typical hydrocarbon polymers.

As a result, there is a need for materials and composites that overcome one or more of the above-described problems or disadvantages of the prior art

The present invention is directed to overcoming one or more of the problems or disadvantages associated with the prior art.

### SUMMARY OF THE INVENTION

The present invention relates to host matrix materials for use in nanocomposite materials. The present invention further relates to be bare, coated, bare core-shell, and coated core-shell nanoparticles.

The present invention further relates to composite materials, such as polymer nanocomposites. The present invention further relates to composite materials comprising a plurality of nanoparticles. The present invention also relates to composite materials comprising a host matrix and a plurality of nanoparticles within the halogenated host matrix. A halogenated outer layer may coat the nanoparticles themselves.

The present invention further relates to a composite material comprising a host matrix, and a plurality of nanoparticles within the host matrix.

In one embodiment, there is a process of forming a composite material comprising the steps of coating each of a plurality of nanoparticles with a halogenated outer layer, and dispersing the plurality of coated nanoparticles into a host matrix material.

In another embodiment there is an optical waveguide comprising a core for transmitting incident light, and a cladding material disposed about the core. In a further embodiment, the core of the optical waveguide comprises a host matrix, and a plurality of nanoparticles dispersed within the host matrix, where the plurality of nanoparticles may includes a halogenated outer coating layer.

### DESCRIPTION OF THE DRAWINGS

In the drawings:

FIG. 1 depicts a schematic representation of an exemplary composite material according to one embodiment of the invention.

FIG. 2 depicts a schematic cross-sectional view of a waveguide according to another embodiment of the present invention.

FIG. 3 depicts a schematic representation of waveguides showing one embodiment according to the present invention.

FIG. 4 depicts a schematic representation of another waveguide embodiment of the present invention.

FIG. 5 depicts schematic representation of a composite material comprising nanoparticles according to another embodiment of the present invention.

FIG. 6 depicts a schematic representation of nanoparticles according to another embodiment of the present invention.

FIG. 7 depicts a flowchart representing a process for forming a composite material according to one embodiment of the present invention.

FIG. 8 depicts an Atomic Force Microscope (AFM) image of nanoparticles.

FIG. 9 depicts the optical loss as a function of the nanoparticles size at two different wavelengths.

FIG. 10 depicts the optical loss as a function of the nanoparticles size at two different wavelengths.

FIG. 11 depicts the optical loss as a function of the nanoparticles sizes at two different wavelengths.

FIG. 12 depicts the scattering loss with pore diameter for a fluoropolymer, with different fractions of residual porosity.

FIG. 13 depicts the optical articles comprising the polymer nanocomposite according to one embodiment of the invention.

### DETAILED DESCRIPTION OF THE INVENTION

In the following description, reference is made to the accompanying drawings that form a part thereof, and in which is shown by way of illustration specific exemplary embodiments in which the invention can be practiced. These embodiments are described in sufficient detail to enable those skilled in the art to practice the invention, and it is to be understood that other embodiments can be utilized and that changes can be made without departing from the scope of the present invention.

For the purpose of this disclosure the distribution of nanoparticles in a matrix is termed a composite material. Composite materials comprising nanoparticles distributed within a polymer matrix material may offer desirable properties. They may for example, improve the thermal stability, chemical resistance, biocompatibility of components and materials comprising them. In one embodiment, the small size of the nanoparticles may impart the composite material with properties derived from the nanoparticles without significantly affecting other properties of the matrix material. For example, nanoparticles may be smaller than the wavelength of incident light, typically within a range of between of about 1200 nm to about 1700 nm, such that incident light does not interact with the nanoparticles. In other words, the incident light does not scatter from interactions with the nanoparticles. Therefore, when appropriately sized nanoparticles are distributed within a transparent host matrix, the host matrix material may remain optically transparent because scattering of the light incident upon the nanoparticles within the host matrix material is insignificant or absent.

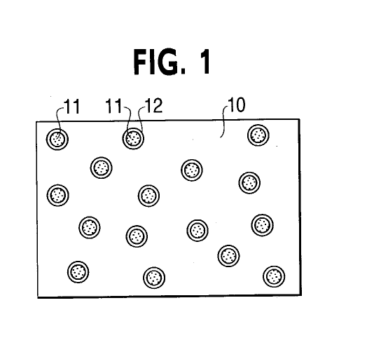

FIG. 1 provides a diagrammatic representation of a composite material according to an embodiment of the invention. In one embodiment, the composite material includes random glassy polymer host matrix 10 and plurality of nanoparticles 11 dispersed either uniformly or non-uniformly within the host matrix 10. Suitable host matrix may comprise an amorphous organic polymer. Organic polymers may include typical hydrocarbon polymers and halogenated polymers. It is generally desirable that in an optical component, such as a planar optical waveguide, an optical fiber, an optical film, or a bulk optical component, e.g., an optical lens or prism, the total optical loss, consisting of both absorption and the scattering loss, be kept at a minimum.

Among the various mechanisms of optical scattering loss, an important factor is the porosity of the optical material. As a result of the interplay between various material characteristics, e.g., surface energy, solubility, glass transition temperature, entropy, etc., and processing conditions, e.g. temperature, pressure, atmosphere, etc., optical materials, such as amorphous perfluoropolymers can exhibit a large amount of nanoporous structures under normal processing conditions. Such nanoporous structures can cause optical scattering loss and should be eliminated, or converted to smaller sizes, in order to satisfy a certain low optical loss device performance requirement. By controlling the pore sizes and pore structures, optical scattering losses can be greatly reduced. For discrete nanopores that are approximately spherical in shape and are evenly distributed into a host matrix, the scattering loss α, in dB per unit length, resulting from the presence of the nanopores, is dependent on the pore diameter d, the refractive index ratio of the pores and the surrounding host material m=nₚₒᵣ/nₛᵤᵣ, and the volume fraction of the nanopores in the host Vₚ. The nanopore induced scattering loss can be calculated by:

$$α = 1.692 \times {10}^{3} {( \frac{{m}^{2} - 1}{{m}^{2} + 2} )}^{2} \frac{{d}^{3} {V}_{p}}{{λ}^{4}} , \qquad ( 1 )$$

wherein λ is the vacuum propagation wavelength of the light guided inside the waveguide. As an example, when m=1.3, Vₚ=10%, λ=1550 nm, d=10 nm, the calculated scattering loss α is 0.001 dB/cm. To fabricate a certain optical component with a set loss specification, and therefore a nanopore induced scattering loss budget of α, the nanopore diameter d should satisfy the following relationship:

$$d < {( α \frac{1}{1.692 \times {10}^{3}} {( \frac{{m}^{2} + 2}{{m}^{2} - 1} )}^{2} \frac{{λ}^{4}}{{V}_{p}} )}^{1 / 3} , \qquad ( 2 )$$

wherein λ is the vacuum propagation wavelength of the light guided inside the waveguide, m=nₚₒᵣ/nₛᵤᵣ the refractive index ratio of the nanopores and the host material, and Vₚ the volume fraction of the nanopores in the host material. For example, following Equation 2, with a nanopore loss budget of α=0.5 dB/cm, when m=1.3, Vₚ=10%, A=1550 nm, the nanopore diameter d must be smaller than 37 nm. In certain embodiments, the diameter of the nanopores should be smaller than 100 nm, and further smaller than 50 nm.

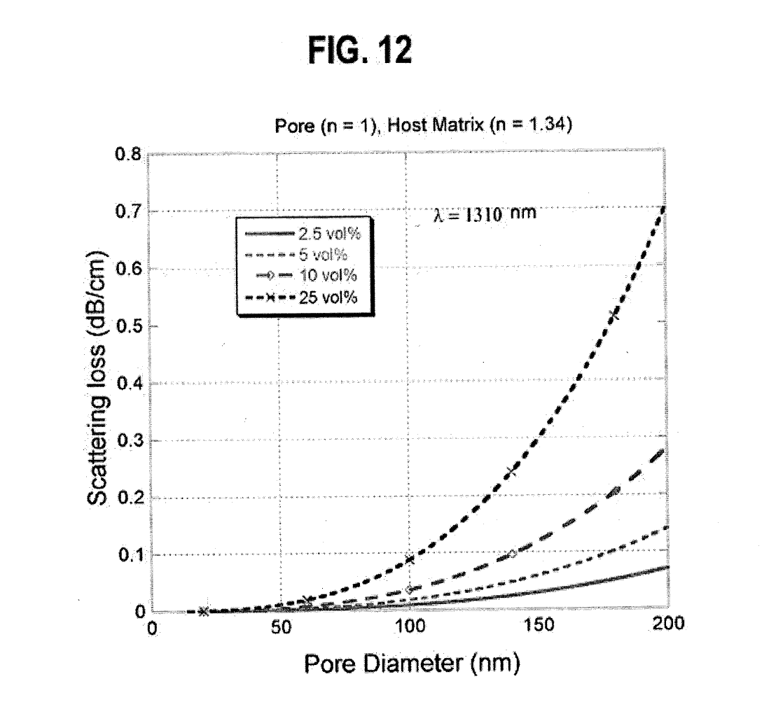

By treating the pores as spherical particles of refractive index equal to 1, the expected scattering loss as function of pore diameter, for wavelength (λ) equals 1310 nm, as shown in FIG. 12. For the case of nanopores in a fluoropolymer film (n=1.34), a residual porosity of 5 vol % with an average diameter of 20 nm, would lead to a scattering loss of 1.4×10⁻⁴ dB/cm at λ=1310 nm. Such residual nanoporosity does not lead to any significant scattering loss. However, for film which was highly porous, with a porosity volume fraction as high as 25%, scattering losses will remain below 7×10⁻⁴ dB/cm as long as the pore diameter does not exceed 20 nm.

Nanoporous materials comprising nanopores distributed within a host matrix material may be used in optical applications. For example, in a waveguide structure comprised of a uniform square, or circular, waveguide cross-section, the waveguide material should exhibit little, or no, optical attenuation, or loss, in signal propagation through the material. A potential source for loss dependent behavior are material scattering centers such as relatively extensive pore or void structures present in the waveguide material.

Thus, nanopores can be distributed in the host matrix in great numbers as separate individual pores, or as joined clusters, some even extending as a continuous interconnected network-like structure over the entire material sample, thereby forming a nanoporous structure.

Clustering of the nanopores within the host matrix material may result in a porous material that lacks a desired characteristic. Specifically, when nanopores fuse together, the larger nanoporous structures formed may not behave in a similar way to the smaller nanopores. For example, while nanopores may be small enough to avoid scattering light within the matrix material, fused pores may be sufficiently large to cause scattering. As a result, a host matrix material may become substantially less transparent in the presence of such nanoporous structures.

Thus, for example, of many potential host matrix polymer materials, halogenated polymers have been shown to have potential to be used in the optical field. Halogenated polymers, such as fluoropolymers, are well known to be problematic toward pore-like structures. However, in the optical field, the presence of such porous structures, especially on nanometer length scales, in optical articles made of halogenated polymers can ultimately cause light to scatter, especially, for example, in optical waveguides from thin films and fibers, thereby resulting in significant optical signal attenuation. To achieve lower optical loss, it is, therefore, important to control the size and distribution of the nanopores and associated nanoporous structures.

In one embodiment, the host matrix 10 may comprise a polymer, a copolymer, a terpolymer, either by itself or in a blend with other matrix material..

In another embodiment, the host matrix 10 can comprise a halogenated elastomer, a perhalogenated elastomer, a halogenated plastic, or a perhalogenated plastic, either by itself or in a blend with other matrix material listed herein.

In yet another embodiment, the host matrix 10 may comprise a polymer, a copolymer, or a terpolymer, having at least one halogenated monomer represented by one of the following formulas:

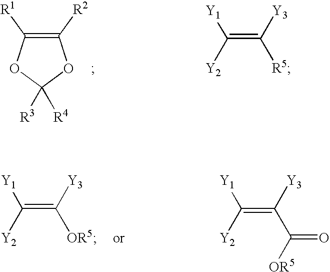

wherein R¹, R², R³, R⁴, and R⁵, which may be identical or different, are each chosen from linear or branched hydrocarbon-based chains, possibly forming at least one carbon-based ring, being saturated or unsaturated, wherein at least one hydrogen atom of the hydrocarbon-based chains may be halogenated; a halogenated alkyl, a halogenated aryl, a halogenated cyclic alky, a halogenated alkenyl, a halogenated alkylene ether, a halogenated siloxane, a halogenated ether, a halogenated polyether, a halogenated thioether, a halogenated silylene, and a halogenated silazane. Y₁ and Y₂, which may be identical or different, are each chosen from H, F, Cl, and Br atoms. Y₃ is chosen from H, F, Cl, and Br atoms, CF₃, and CH₃.

Alternatively, the polymer may comprise a condensation product made from the monomers listed below:

HO—R—OH+NCO—R′—NCO; or

HO—R—OH+Ary¹-Ary²,

wherein R, R′, which may be identical or different, are each chosen from halogenated alkylene, halogenated siloxane, halogenated ether, halogenated silylene, halogenated arylene, halogenated polyether, and halogenated cyclic alkylene. Ary¹, Ary², which may be identical or different, are each chosen from halogenated aryls and halogenated alkyl aryls.

Ary as used herein, is defined as being a saturated, or unsaturated, halogenated aryl, or a halogenated alkyl aryl group.

Alternatively, the host matrix 10 can comprise a halogenated cyclic olefin polymer, a halogenated cyclic olefin copolymer, a halogenated polycyclic polymer, a halogenated polyimide, a halogenated polyether ether ketone, a halogenated epoxy resin, a halogenated polysulfone, or halogenated polycarbonate.

In certain embodiments, the host matrix 10, for example, a fluorinated polymer host matrix 10, may exhibit very little absorption loss over a wide wavelength range. Therefore, such fluorinated polymer materials may be suitable for optical applications.

In one embodiment, the halogenated aryl, alkyl, alkylene, alkylene ether, alkoxy, siloxane, ether, polyether, thioether, silylene, and silazane groups are at least partially halogenated, meaning that at least one hydrogen in the group has been replaced by a halogen. In another embodiment, at least one hydrogen in the group may be replaced by fluorine. Alternatively, these aryl, alkyl, alkylene, alkylene ether, alkoxy, siloxane, ether, polyether, thioether, silylene, and silazane groups may be completely halogenated, meaning that each hydrogen of the group has been replaced by a halogen. In an exemplary embodiment, the aryl, alkyl, alkylene, alkylene ether, alkoxy, siloxane, ether, polyether, thioether, silylene, and silazane groups may be completely fluorinated, meaning that each hydrogen has been replaced by fluorine. Furthermore, the alkyl and alkylene groups may include between 1 and 12 carbon atoms.

Additionally, host matrix 10 may comprise a combination of one or more different halogenated polymers, such as fluoropolymers, blended together. Further, host matrix 10 may also include other polymers, such as halogenated polymers containing functional groups such as phosphinates, phosphates, carboxylates, silanes, siloxanes, sulfides, including POOH, POSH, PSSH, OH, SO₃H, SO₃R, SO₄R, COOH, NH₂, NHR, NR₂, CONH₂, NH—NH₂, and others, where R may comprise any of aryl, alkyl, alkylene, siloxane, silane, ether, polyether, thioether, silylene, and silazane. Further, host matrix 10 may also include homopolymers or copolymers of vinyl, acrylate, methacrylate, vinyl aromatic, vinyl esters, alpha beta unsaturated acid esters, unsaturated carboxylic acid esters, vinyl chloride, vinylidene chloride, and diene monomers. Further, the host matrix may also include a hydrogen-containing fluoroelastomer, a hydrogen-containing perfluoroelastomer, a hydrogen containing fluoroplastic, a perfluorothermoplastic, at least two different fluoropolymers, or a cross-linked halogenated polymer.

Examples of the host matrix 10 include: poly[2,2-bistrifluoromethyl-4,5-difluoro-1,3-dioxole-co-tetrafluoroethylene], poly[2,2-bisperfluoroalkyl-4,5-difluoro-1,3-dioxole-co-tetrafluoroethylene], poly[2,3-(perfluoroalkenyl) perfluorotetrahydrofuran], poly[2,2,4-trifluoro-5-trifluoromethoxy-1,3-dioxole-co-tetrafluoroethylene], poly(pentafluorostyrene), fluorinated polyimide, fluorinated polymethylmethacrylate, polyfluoroacrylates, polyfluorostyrene, fluorinated polycarbonates, fluorinated poly (N-vinylcarbazole), fluorinated acrylonitrile-styrene copolymer, fluorinated Nafion®, fluorinated poly(phenylenevinylene), perfluoro-polycyclic polymers, polymers of fluorinated cyclic olefins, or copolymers of fluorinated cyclic olefins.

Additionally, the host matrix may comprise any polymer sufficiently clear for optical applications. Examples of such polymers include polymethylmethacrylates, polystyrenes, polycarbonates, polyimides, epoxy resins, cyclic olefin copolymers, cyclic olefin polymers, acrylate polymers, PET, polyphenylene vinylene, polyether ether ketone, poly (N-vinylcarbazole), acrylonitrile-styrene copolymer, or poly(phenylenevinylene).

By including halogens, such as fluorine, into host matrix 10, the optical properties of host matrix 10 and the resulting composite material are improved over conventional composite materials. Unlike the C—H bonds of hydrocarbon polymers, carbon-to-halogen bonds (such as C—F) shift the vibrational overtones toward longer wavelengths out of the ranges used in telecommunication applications. For example, the carbon-to-halogen bonds exhibit vibrational overtones having low absorption levels ranging from about 0.8 μm to about 0.9 μm, and ranging from about 1.2 μm to 1.7 μm. As hydrogen is removed through partial to total halogenation, the absorption of light by vibrational overtones is reduced. One parameter that quantifies the amount of hydrogen in a polymer is the molecular weight per hydrogen for a particular monomeric unit. For highly halogenated polymers useful in optical applications, this ratio may be 100 or greater. This ratio approaches infinity for perhalogenated materials.

One class of composite materials includes nanoparticles distributed within a host matrix material. Nanoparticles are particles of a material that have a size measured on a nanometer scale. Generally, nanoparticles are larger than a cluster (which might be only a few hundred atoms in some cases), but with a relatively large surface area-to-bulk volume ratio. While most nanoparticles have a size from about 10 nm to about 500 nm, the term nanoparticles can cover particles having sizes that fall outside of this range.

For example, particles having a size as small as about 1 nm and as large as about1×10³ nm could still be considered nanoparticles. By introducing nanoparticles into optically transparent host matrix, the absorption and scattering losses due to the nanoparticles may add to the optical loss. In order to keep the optical loss to a minimum, in addition to controlling the loss contribution from the host matrix, it is essential to control the absorption and scattering loss from the nanoparticles doped into the host matrix for optical applications.

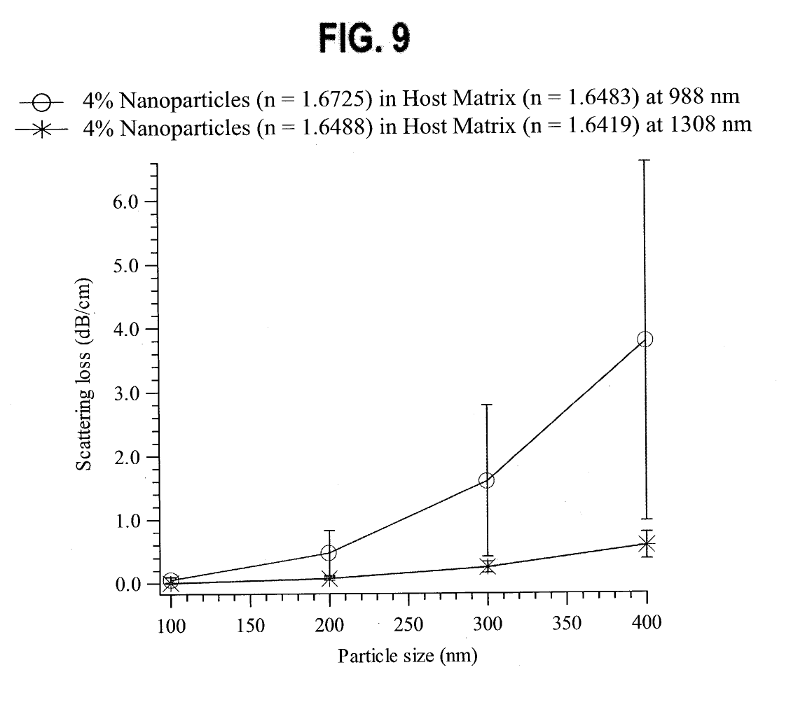

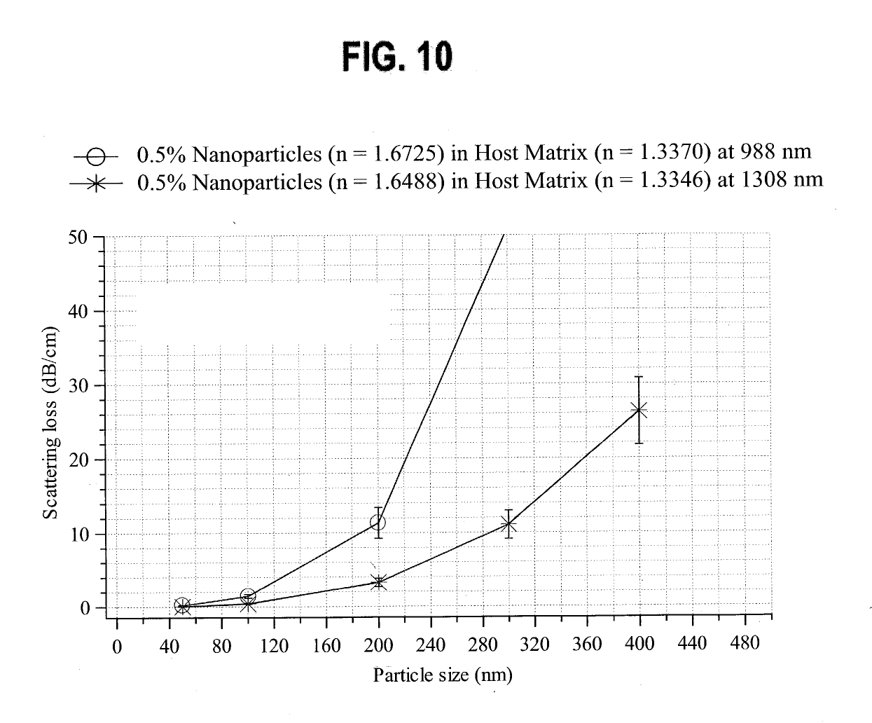

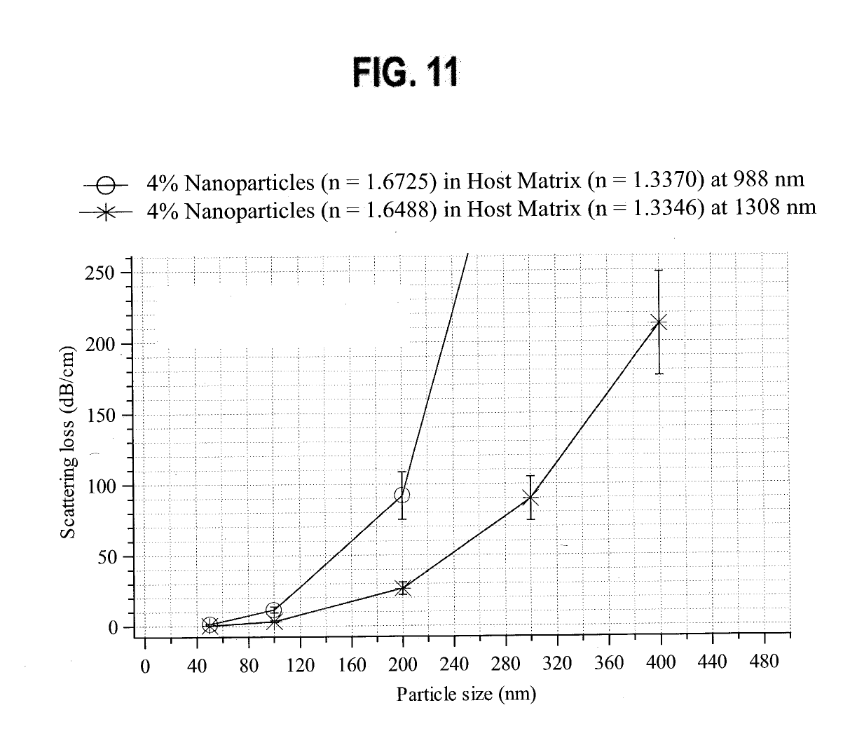

FIGS. 9, 10, and 11 provide examples of scattering loss due to the presence of nanoparticles. Nanocomposite containing nanoparticles with a refractive index of about 1.6725 and a host material with a refractive index of about 1.6483 at 988 nm exhibit a loss of about 0.6 dB/cm. On the other hand, when the index mismatch between the host and the nanoparticles is large, high scattering loss is expected when the particle size exceeds 50 nm as shown in FIGS. 10 and 11. The presence of small nanoparticles with particle diameter less than 20 nm even at high nanoparticles loading (4 vol %) does not lead to any significant scattering loss. Therefore, it is necessary to keep the nanoparticles size below 20 nm in order to maintain the low optical loss caused by the presence of nanoparticles.

Nanoparticles can be made from a wide array of materials. Among these materials examples include, transition metals, rare-earth metals, group VA elements, polymers, dyes, semiconductors, alkaline earth metals, alkali metals, group IIIA elements, and group IVA elements Nanoparticles can be made from a wide array of materials. Among these materials examples include metal, glass, ceramics, refractory materials, dielectric materials, carbon or graphite, natural and synthetic polymers including plastics and elastomers, dyes, ion, alloy, compound, composite, or complex of transition metal elements, rare-earth metal elements, group VA elements, semiconductors, alkaline earth metal elements, alkali metal elements, group IIIA elements, and group IVA elements or polymers and dyes.

Further, the materials may be crystalline, amorphous, or mixtures, or combinations of such structures. Nanoparticles 11 may be bare, coated, bare core-shell, coated core-shell, Further, nanoparticles themselves may considered a nanoparticle matrix, which may comprise a wide array of materials, single elements, mixtures of elements, stoichiometric or non-stoichiometric compounds. The materials may be crystalline, amorphous, or mixtures, or combinations of such structures.

Moreover, nanoparticles themselves may be considered a nanoparticle matrix, which may comprise a wide array of materials, single elements, mixtures of elements, stoichiometric or non-stoichiometric compounds

A plurality of nanoparticles 11 may include an outer coating layer 12, which at least partially coats nanoparticles 11 and inhibits their agglomeration. Suitable coating materials may have a tail group, which is compatible with the host matrix, and a head group, that could attach to the surface of the particles either through physical adsorption or chemical reaction. The nanoparticles 11 according to the present invention may be doped with an effective amount of dopant material. An effective amount is that amount necessary to achieve the desired result. The nanoparticles of doped glassy media, single crystal, or polymer are embedded in the host matrix core material 10. The active nanoparticles may be randomly and uniformly distributed. The nano-particles of rare-earth doped, or co-doped, glasses, single crystals, organic dyes, or polymers are embedded in the polymer core material. In cases where there is interface delamination due to mismatches of mechanical, chemical, or thermal properties between the nanoparticles and the surrounding polymer core host matrix, a compliance layer may be coated on the nanoparticles to enhance the interface properties between the nanoparticles and the host matrix polymer core material.

As shown in FIG. 1, the nanoparticles may include an outer layer 12. As used herein, the term layer is a relatively thin coating on the outer surface of an inner core (or another inner layer) that is sufficient to impart different characteristics to the outer surface. The layer need not be continuous or thick to be an effective layer, although it may be both continuous and thick in certain embodiments.

Nanoparticles 11 may comprise various different materials, and they may be fabricated using several different methods. In one embodiment of the invention, the nanoparticles are produced using an electro-spray process. In this process, very small droplets of a solution including the nanoparticle precursor material emerge from the end of a capillary tube, the end of which is maintained at a high positive or negative potential. The large potential and small radius of curvature at the end of the capillary tube creates a strong electric field causing the emerging liquid to leave the end of the capillary as a mist of fine droplets. A carrier gas captures the fine droplets, which are then passed into an evaporation chamber. In this chamber, the liquid in the droplets evaporates and the droplets rapidly decrease in size. When the liquid is entirely evaporated, an aerosol of nanoparticles is formed. These particles may be collected to form a powder or they may be dispersed into a solution. The size of the nanoparticles is variable and depends on processing parameters.

In an exemplary embodiment of the present invention, nanoparticles 11 have a major dimension of less than about 50 nm. That is, the largest dimension of the nanoparticle (for example the diameter in the case of a spherically shaped particle) is less than about 50 nm and in further embodiments about 20 nm.

Other processes are also useful for making the nanoparticles 11 of the present invention. For example, the nanoparticles may be fabricated by laser ablation, laser-driven reactions, flame and plasma processing, solution-phase synthesis, sol-gel processing, spray pyrolysis, flame pyrolysis, laser pyrolysis, flame hydrolysis, mechanochemical processing, sono-electro chemistry, physical vapor deposition, chemical vapor deposition, mix-alloy processing, decomposition-precipitation, liquid phase precipitation, high-energy ball milling, hydrothermal methods, glycothermal methods, vacuum deposition, polymer template processes, micro emulsion processes or any other suitable method for obtaining particles having appropriate dimensions and characteristics. The sol-gel process is based on the sequential hydrolysis and condensation of alkoxides, such as metal alkoxides, intiated by an acidic or a basic aqueous solution in the presence of a cosolvent. Controlling the extent of hydrolysis and condensation reactions with water, surfactants, or coating agents can lead to final products with particle diameters in the nanometer range. The sol-gel process can be used to produce nanoscale metal, ceramic, glass and semiconductor particles. The size of nanoparticles made from varieties of methods can be determined using Transmission Electron Microscope (TEM), Atomic Force Microscope (AFM), or surface area analysis. For crystalline materials, X-ray powder diffraction pattern can also be used to calculate the crystallite size based on line broadening according to a procedure described in Chapter 9 of “X-Ray Diffraction Procedure”, published by Wiley in 1954.

The presence of the nanoparticles can affect other properties of the composite material. For example, for optical applications, the nanoparticle material may be selected according to a particular, desired index of refraction. For certain structural applications, the type of material used to form the nanoparticles 11 may be selected according to its thermal properties, or coefficient of thermal expansion. Still other applications may depend on the mechanical, magnetic, electrical, thermo-optic, magneto-optic, electro-optic or acousto-optic properties of the material used to form nanoparticles 11.

Several classes of materials may be used to form nanoparticles 11 depending upon the effect the nanoparticles are to have on the properties of the composite containing them. In one embodiment, nanoparticles 11 may include one or more active materials, which allow the composite to be a gain medium. Active materials act as gain media toward a light signal as the light signal encounters the active material. Active materials may include transition metal elements, rare-earth metal elements, the actinide element uranium, group VA elements, semiconductors, and group IVA elements in the forms of ions, alloys, compounds, composites, complexes, chromophores, dyes or polymers. Examples of such active materials include but are not limited to Ce³⁺, Pr³⁺, Nd³⁺, Pm³⁺, Sm³⁺, Eu³⁺, Gd³⁺, Tb³⁺, Dy³⁺, Er³⁺, Tm³⁺, Yb³⁺, V²⁺, V³⁺, Cr2+, Cr³⁺, Cr⁴⁺, Mn⁵⁺, Co²⁺, Fe²⁺, Ni²⁺, Ti³⁺, U³⁺, and Bi³⁺, as well as the semiconductors such as Si, Ge, SiGe, GaP, GaAs, InP, InAs, InSb, PbSe, PbTe. Active materials can also comprise combinations of the above mentioned materials ranging from 0.17 μm to 7.2 μm.

The material that forms the matrix of nanoparticle 11 may be in the form of ions, alloys, compounds, composites, complexes, chromophores, dyes or polymers, and may comprise the following: an oxide, phosphate, halophosphate, phosphinate, arsenate, sulfate, borate, aluminate, gallate, silicate, germanate, vanadate, niobate, tantalaite, tungstate, molybdate, alkalihalogenate, halogenide, nitride, selenide, sulfide, sulfoselenide, tetrafluoroborate, hexafluorophosphate, phosphonate, and oxysulfide.

In certain embodiments, the transition metal ions V²⁺, V³⁺, Cr²⁺, Cr³⁺, Cr⁴+, Mn⁵⁺, Co²⁺, Fe²⁺, Ni²⁺, B³+and Ti³⁺, for example, alone or together may be incorporated in a nanoparticle for gain media ranging from about 0.61 μm to 3.5 μm.

In additional embodiments, the rare earth ions Ce³⁺, Pr³⁺, Nd³⁺, Pm³⁺, Sm³⁺, Eu³⁺, Gd³⁺, Tb³⁺, Dy³⁺, Ho³⁺, Er³⁺, Tm³+and Yb³⁺, for example, alone or together may be incorporated in a nanoparticle for gain media ranging from about 0.17 μm to 7.2 μm.

In further embodiments, the metal ions U³⁺, and Bi³⁺ for example, alone or together may be incorporated in a nanoparticle for gain media ranging from about 2.2 μm to 2.8 μm, and near 1.3 μm, respectively.

In certain embodiments, Er³⁺ and Yb³⁺, for example, alone or together may be incorporated in a nanoparticle for gain media ranging from about 0.9 μm to 1.1 μm and from about 1.5 μm to about 1.6 μm.

In certain embodiments, Er³⁺ and Cr⁴⁺, for example, alone or together may be incorporated in a nanoparticle for gain media ranging from about 1.2 μm to 1.4 μm and from about 1.5 μm to about 1.6 μm.

In certain embodiments, Er³⁺ is alone or together co-doped with other active ions in crystal nanoparticles for amplification ranging from about 1.5 μm to about 1.6 μm, further about 1.55 μm. In another embodiment, several separate species of nanoparticles containing an active ion such as Er³⁺, and other active ions may be doped into the polymer hosts. For example, Yb³⁺ can be co-doped into the nanoparticles containing Er³⁺ to increase the absorption cross section for the pump laser. Additionally, Yb³⁺ can be doped into the polymer hosts separate from the active Er³⁺ nanoparticles to achieve the same sensitization effect.

In certain embodiments, Cr⁴⁺ is alone or together co-doped with other active ions in crystal nanoparticles for amplification ranging from about 1.2 μm to about 1.4 μm, further about 1.31 μm. In another embodiment, several separate species of nanoparticles containing an active ion such as Cr⁴⁺, and other active ions may be doped into the polymer hosts. For example, Yb³⁺ can be co-doped into the nanoparticles containing Cr⁴⁺ to increase the absorption cross section for the pump laser. Additionally, Yb³⁺ can be doped into the polymer hosts separate from the active Cr⁴⁺ nanoparticles to achieve the same sensitization effect.

In certain embodiments, Er and Cr⁴⁺ are together or co-doped with other active ions in crystal nanoparticles for amplification ranging from about 1.2 μm to about 1.4 μm and from 1.5 μm to about 1.6 μm, further about 1.3 μm and about 1.55 μm. In another embodiment, several separate species of nanoparticles containing an active ion such as Er and Cr⁴⁺, and other active ions may be doped into the polymer hosts. For example, Yb can be co-doped into the nanoparticles containing Er or Cr⁴⁺ to increase the absorption cross section for the pump laser. Additionally, Yb can be doped into the polymer hosts separate from the active Er or Cr⁴⁺ nanoparticles to achieve the same sensitization effect.

In certain embodiments, Pr³⁺, Dy³⁺, Nd³⁺, and Bi³⁺ alone or together may be incorporated in a nanoparticle for gain media ranging from about 1.27 μm to about 1.35 μm, and further about 1.3 μm, and yet further about 1.31 μm.

In another embodiment, Pr³⁺, Dy³⁺, and Nd³⁺ alone or together with other rare-earth elements, such as Yb³⁺, may be incorporated in a nanoparticle for gain media ranging from about 1.27 μm to about 1.35 μm, and further about 1.3 μm, and yet further about 1.31 μm.

The material that forms the matrix of nanoparticle 11 may be in the form of an ion, alloy, compound, or complex, and may comprise the following: an oxide, phosphate, halophosphate, phosphinate, arsenate, sulfate, borate, aluminate, gallate, silicate, germanate, vanadate, niobate, tantalite, tungstate, molybdate, alkalihalogenate, halogenide, nitride, selenide, sulfide, sulfoselenide, tetrafluoroborate, hexafluorophosphate, phosphonate, and oxysulfide.

In certain embodiments, the semiconductor materials, for example, Si, Ge, SiGe, GaP, GaAs, GaN, InP, InAs, InSb, PbSe, PbTe, InGaAs, and other stoichiometries as well as compositions, alone, or together, or doped with an appropriate ion may be incorporated in a nanoparticle for gain media ranging from about 0.4 μm to 1.6μm.

Metal containing materials such as metal chalocogenides, metal salts, transition metals, transition metal complexes, transition metal containing compounds, transition metal oxides, and organic dyes, such as, for example, Rodamin-B, DCM, Nile red, DR-19, and DR-1, and polymers may be used. ZnS, or PbS doped with a rare-earth or transition metal for gain media can also be used to form nanoparticles.

The present invention also encompasses a method for amplifying a light signal. According to certain embodiments of the present invention, the composite materials may comprise a gain medium for light amplification. For example, Er³⁺ alone, or together with other rare-earth elements, or transition metal elements, may be incorporated in a nanoparticle for amplification ranging from about 1.5 μm to about 1.6 μm for broad band amplification depending on the other rare-earth elements or transition metal elements. All the above cited gain media can be used for optical amplification.

The present invention also encompasses a method for lasing a light. For example, Nd³⁺ alone, or together with other rare-earth elements, or transition metal elements, may be incorporated in a nanoparticle for lasing ranging from about 1.06 μm to about 1.3 μm for broad band operation depending on the other rare-earth elements or transition metal elements. All the above cited gain media can be used for lasing of light.

A laser can also be made consistent with this invention. As used herein, a laser includes a cavity with at least partially reflective surfaces (e.g., mirrors) at the ends and at least partially filled with an optical gain medium. The laser cavity sets up an optical resonant structure in which lasing activity begins when multiple reflections accumulate electromagnetic field intensity.

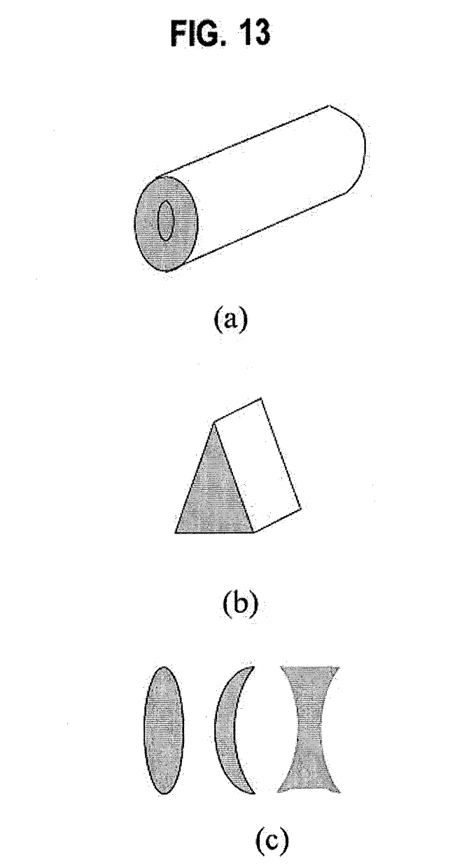

An optical fiber is one type of waveguide that can be made consistent with this invention, as shown in FIG. 13a. The waveguide may comprise the composite materials according to the present invention. Another type of waveguide that can be made consistent with this invention is a planar waveguide. A planar waveguide core according to the present invention can have a cross-section that is, for example, substantially square, or any other shape that is conveniently fabricated. When a pump laser beam passes through the waveguide, external energy can be applied (e.g., at IR wavelengths), thereby pumping, or exciting, the excitable atoms in the gain medium and increasing the intensity of the signal beam passing there through. A signal beam emerging from the amplifier can retain most its original characteristics, but is more intense than the input beam.

Many types of optical amplifiers can be made consistent with this invention, including narrow-band optical amplifiers, such as 1.55 μm optical amplifiers, 1.31 μm optical amplifiers, and ultra-broadband amplifiers.

An ultra-broadband optical amplifier consistent with this invention can span more than about 60 nanometers. In one embodiment, such an amplifier can span more than about 400 nanometers, far more than the bandwidth of amplifiers used in conventional commercial wavelength-division multiplexed communications systems, which normally only span about 30 to 60 nanometers. An optical network that uses an ultra-broadband amplifier consistent with this invention can handle, for example, hundreds of different wavelength channels, instead of the 16 or so channels in conventional networks, thereby greatly increasing capacity and enhancing optical-layer networking capability. In the case of erbium-doped waveguides, seeded techniques can be used to broaden and shift the output wavelength to make a better L-band and broad-band amplifier.

Several classes of materials may be used to form nanoparticles 11 depending upon the effect the nanoparticles are to have on the properties of the composite containing them. In one embodiment, nanoparticles 11 may include one or more active materials, which allow the composite to be a novel optical medium. Active materials change the index of refraction of the composite material. Active materials may include nanoparticles 11 made from metals, semiconductors, dielectric insulators, and various forms and combinations of ions, alloys, compounds, composites, complexes, chromophores, dyes or polymers.

In one embodiment, the metal oxide TiO₂, for example, may be incorporated in a nanoparticle for tuning and control of the index of refraction of the composite material.

In another embodiment, nanopores with index of refraction equal to 1, for example, may be incorporated in a host matrix for tuning and control of the index of refraction of the composite material.

In a further embodiment, the semiconductor materials having the index of refraction values between about 2 and 5, for example, may be incorporated in a nanoparticle for tuning and control of the index of refraction of the composite material. These materials include, for example, Si, Ge, SiGe, GaP, GaAs, InP, InAs, InSb, ZnS, PbS, PbSe, PbTe, InGaAs, and other stoichiometries as well as compositions, alone, or together, or doped with appropriate ions.

In a further embodiment, the inorganic materials having the index of refraction values between about 1 and 4, for example, may be incorporated in a nanoparticle for tuning and control of the index of refraction of the composite material. These materials include, for example, TiO₂, SiO₂, B₂O₃, P₂O₅, Ge₂O₃, ZnO₂, LiNbO₃, BaTiO₃, YAlO₃, Proustite, Zirconate, and other related materials as well as their counterparts doped with appropriate ions.

Inclusion of nanoparticles, or nanopores, 11 into host matrix material 10, in certain applications according to the present invention, may provide a composite material useful in optical waveguide applications. For example, nanoparticles 11 provide the capability of fabricating a waveguide material having a particular index of refraction. By controlling the index of refraction in this way, transmission losses in optical waveguides resulting from index of refraction mismatches in adjacent materials could be minimized. Additionally, because of the small size of nanoparticles 11, the composite material may retain all of the desirable transmission properties of the host matrix material 10. Using the nanoparticles disclosed herein, the index of refraction is tuned to from about 1 to about 5.

One method to manufacture the waveguide assemblies according to the present invention, begin by first preparing the substrate. The surface of the substrate is cleaned to remove any adhesive residue that may be present on the surface of the substrate. Typically, a substrate is cast or injection molded, providing a relatively smooth surface on which it can be difficult to deposit a perfluoropolymer, owing to the non-adhesive characteristics of perfluoropolymers in general. After cleaning, the substrate is prepared to provide better adhesion of the lower cladding to the surface of the substrate. The substrate can be prepared by roughening the surface or by changing the chemical properties of the surface to better retain the perfluoropolymer comprising the lower cladding layer. One example of the roughening method is to perform reactive ion etching (RIE) using argon. The argon physically deforms the surface of the substrate, generating a desired roughness of approximately 50 to 100 nanometers in depth. One example of the method that can change the chemical properties of the surface of the substrate is to perform RIE using oxygen. The oxygen combines with the polymer comprising the surface of the substrate, causing a chemical reaction on the surface of the substrate and oxygenating the surface of the substrate. The oxygenation of the substrate can allow the molecules of the perfluoropolymer comprising the lower cladding to bond with the substrate. Those skilled in the art will recognize that other methods can also be used to prepare the substrate.

The lower cladding is then deposited onto the substrate. For a lower cladding constructed from poly[2,2,4-trifluoro-5-trifluoromethoxy-1,3-dioxole-co-tetrafluoroethylene], solid poly[2,2,4-trifluoro-5-trifluoromethoxy-1,3-dioxole-co-tetrafluoroethylene] is dissolved in a solvent, perfluoro (2-butyltetrahydrofuran), which is sold under the trademark FC-75, as well as perfluoroalkylamine, which is sold under the trademark FC-40. Other potential solvents are a perfluorinated polyether, such as that sold under the trademark H GALDEN® series HT170, or a hydrofluoropolyether, such as that sold under the trademarks H GALDEN® series ZT180 and ZT130. For a lower cladding constructed from other polymers, each polymer is dissolved in a suitable solvent to form a polymer solution. The polymer solution is then spin-coated onto the substrate using known spin-coating techniques. The substrate and the lower cladding are then heated to evaporate the solvent from the solution.

In one embodiment, the lower cladding is spin-coated in layers, such that a first layer is applied to the substrate, baked to evaporate the solvent, and annealed to densify the polymer, a second layer is applied to the first layer and densified, and a third layer is applied to the second layer and densified. For example, after all of the layers are applied, the lower cladding achieves a height ranging from 8 to 12 micrometers. Although the application of three layers is described, those skilled in the art will recognize that more or less than three layers can be used.

After the lower cladding has dried and densified, the polymer core is deposited onto the lower cladding, for example, using the same technique as described above to deposit the lower cladding onto the substrate. Instead of depositing several sub-layers of the core onto the lower cladding, however, only one layer of the core is deposited, for example, deposited onto the lower cladding. In one embodiment, the core is soluble in a solvent in which the lower cladding is not soluble so that the solvent does not penetrate the lower cladding and disturb the lower cladding. For a core constructed from poly[2,3-(perfluoroalkenyl)perfluorotetrahydrofuran], solid poly[2,3-(perfluoroalkenyl)perfluorotetrahydrofuran] is dissolved in a solvent, such as perfluorotrialkylamine, which is sold under the trademark CT-SOLV 180™, or any other solvent that readily dissolves polymer, forming a polymer solution. Alternatively, poly[2,3-(perfluoroalkenyl)perfluorotetrahydrofuran] can be commercially obtained already in solution. After the core material is applied and dried, the core film is densified using a low temperature baking process. After the core is dried, a thickness of the core and lower cladding is, for example, ranging approximately from 12 to 16 microns.

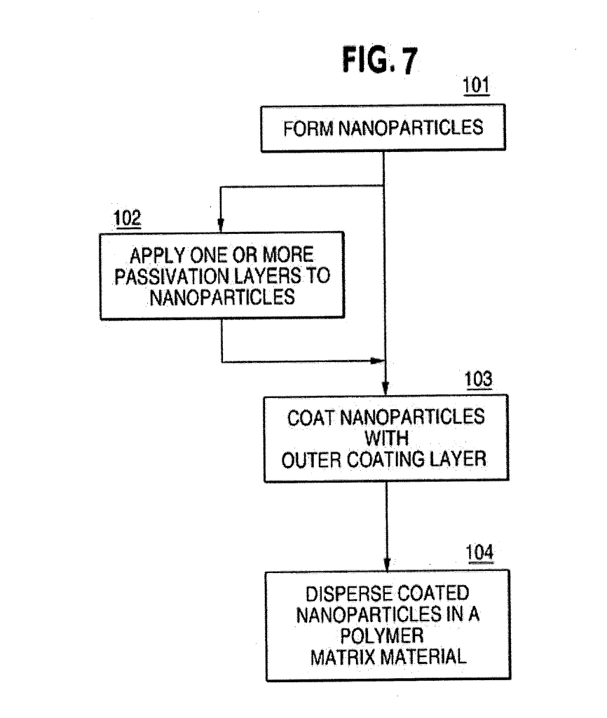

Next, the core is etched to provide a desired core shape. For example, the etching is performed by RIE, which is well known in the art. However, those skilled in the art will also recognize that other methods of etching the core may also be used. While FIG. 7 discloses a generally straight core, those skilled in the art will recognize that other shapes can be used, such as the curved waveguide shape disclosed in a commonly assigned U.S. patent application Ser. No. 09/877,871, filed Jun. 8, 2001, which is incorporated herein by reference in its entirety. Further, while FIG. 7 discloses a generally rectangular cross section for the core, those skilled in the art will recognize that the cross section of the core can be other shapes as well.

Next, the upper cladding is deposited onto the core, the core layer, and any remaining portion of the lower cladding not covered by the core or the core layer. For example, similar to the lower cladding, the upper cladding is spincoated in layers, such that a first layer is applied to the core and a remaining portion of the lower cladding layer not covered by the core, baked to evaporate the solvent, and annealed to densify the polymer, a second layer is applied to the first layer, baked and densified, and a third layer is applied to the second layer, baked, and densified. In one embodiment, the upper cladding is soluble in a solvent in which the core and core layer are not soluble so that the solvent does not penetrate the core and the core layer and disturb the core or the core layer. For example, after all of the layers are applied, the entire waveguide achieves a height ranging approximately from 15 to 50 micrometers. Although the application of three layers is described, those skilled in the art will recognize that more or less than three layers can be used. Alternatively, the upper cladding can be a different material from the lower cladding, but with approximately the same refractive index as the lower cladding, for example, a photocuring fluorinated acrylate or a thermoset.

The layers are not necessarily flat, but contour around the core with decreasing curvature for each successive layer. Although the last layer is shown with a generally flat top surface, those skilled in the art will recognize that the top surface of the last layer need not necessarily be flat. Those skilled in the art will also recognize that single layer claddings with high degrees of flatness or planarization can be achieved by either spincoating or casting processes.

After forming the waveguide, the waveguide is cut to a desired size and shape, for example, by dicing. A desired shape is generally rectangular, although those skilled in the art will recognize that the waveguide can be cut to other shapes as well.

Other examples of optical components that can be made with the disclosed nanoporous materials processing method include, but are not limited to: optical fibers, optical prisms, optical lenses, optical anti-reflection coatings and optical band-pass thin film filters, as illustrated in the FIGS. 13(a) through 13(c).

In certain embodiments, optical fibers, as illustrated in FIG. 13(a), can be made by fabricating the fiber preform, drawing fiber from the preform, and generating nanoporous structures inside the fiber by densification and other methods. Alternatively, optical fibers according to the present invention can be fabricated from nanoporous materials by extrusion methods. Bulk optical components, as illustrated in FIGS. 13(b) and 13(c), such as optical prisms, optical lenses, optical storage diskettes, etc., can be made with nanoporous materials by injection molding, casting, extrusion, etc. Optical thin film band-pass filters and anti-reflection coatings can be fabricated from nanoporous materials by extrusion, casting, spin-coating, etc.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

According to yet another aspect of the present invention, a microresonator is provided that comprises a nanoparticle composite material, as described above, having a shape that is bounded at least in part by a reflecting surface in which electromagnetic radiation having a discrete frequency can set up a standing wave mode. Methods for fabricating microresonators are also provided.

A microresonator according to this invention can be, for example, microring, microdisk, microsphere, and microline. As used herein, a microring resonator is any resonanating device that has a closed-loop shape. A common closed-loop shape is a symmetric torus, but it will be appreciated that other closed-loops can be used as well.

Several classes of materials may be used to form nanoparticles 11 depending upon the effect the nanoparticles are to have on the properties of the composite containing them. In one embodiment, nanoparticles 11 may include one or more active materials, which allow the composite to be a novel electrical medium. Active materials change the electrical conductivity of the composite material. Active materials may include nanoparticles 11 made from metals, semiconductors, dielectric insulators, superconductors, and in various inorganic and organic forms and combinations of ions, alloys, compounds, composites, complexes, chromophores, dyes or polymers.

The present invention also discloses a method of making a nanoporous polymer material by controlling the size, shape, volume fraction, and topological features of the pores, which comprises annealing the polymer material at a temperature above its glass transition temperature. The present invention further discloses the use of the resulting nanoporous polymer material to make devices, such as optical devices.

In one embodiment, the metal Ag, for example, may be incorporated in a nanoparticle for tuning and control of the electrical conductivity of the composite material.

In another embodiment, the semiconductor Si, for example, may be incorporated in a nanoparticle for tuning and control of the electrical conductivity of the composite material.

In a further embodiment, the dielectric insulator SiO₂, for example, may be incorporated in a nanoparticle for tuning and control of the electrical conductivity of the composite material.

In a further embodiment, the super conductor Yttrium Barium Copper Oxide (YBCO), for example, may be incorporated in a nanoparticle for tuning and control of the electrical conductivity of the composite material.

Several classes of materials may be used to form nanoparticles 11 depending upon the effect the nanoparticles are to have on the properties of the composite containing them. In one embodiment, nanoparticles 11 may include one or more active materials, which allow the composite to be a novel dielectric medium. Active materials change the dielectric constant of the composite material. Active materials may include nanoparticles 11 made from dielectric insulators, such as NaCl, TiO₂, SiO₂, B₂O₃, Ge₂O₃, ZnO₂, LiNbO₃, and BaTiO₃, and various forms and combinations of ions, alloys, compounds, composites, complexes, chromophores, dyes or polymers, such as PVDF.

Several classes of materials may be used to form nanoparticles 11 depending upon the effect the nanoparticles are to have on the properties of the composite containing them. In one embodiment, nanoparticles 11 may include one or more active materials, which allow the composite to be a novel magnetic material. Active materials change the magnetic susceptibility of the composite material. Active materials may include nanoparticles 11 made from paramagnetic, ferromagnetic, antiferromagnetic, ferrimagnetic, and diamagnetic materials.

Several classes of materials may be used to form nanoparticles 11 depending upon the effect the nanoparticles are to have on the properties of the composite containing them. In one embodiment, nanoparticles 11 may include one or more active materials, which allow the composite to be a novel mechanical material. Active materials change the mechanical properties of the composite material. Active materials may include nanoparticles 11 and in various forms and combinations of alloys, compounds, crystals, composites, complexes, chromophores, dyes or polymers.

Several classes of materials may be used to form nanoparticles 11 depending upon the effect the nanoparticles are to have on the properties of the composite containing them. In one embodiment, nanoparticles 11 may include one or more active materials, which allow the composite to be a novel electrooptic material. Active materials change the electrooptic coefficient of the composite material. Active materials may include nanoparticles 11 made from electrooptic materials, such as LiNbO₃, KNbO₃, KTiOPO₄, β-BaB₂O₄, KTiOAsO₄, KH₂PO₄, KD₂PO₄, NH₄H₂PO₄, and 2-methyl-4-nitroaniline (MNA).

A dynamic gain equalizing (DGE) filter can be made consistent with the electro-optic material of this invention. A DGE can be used to ensure that all DWDM channels in a single fiber have approximately the same power level, which, in turn, helps to lower data error rates. Unfortunately, power levels become unequal as a signal travels through fiber-optic networks due to various optical components in the network, including optical amplifiers and various environmental factors.

Several classes of materials may be used to form nanoparticles 11 depending upon the effect the nanoparticles are to have on the properties of the composite containing them. In one embodiment, nanoparticles 11 may include one or more active materials, which allow the composite to be a novel magnetooptic material. Active materials change the magneto-optic coefficient of the composite material. Active materials may include nanoparticles 11 made from magneto-optic materials, such as YVO₄, TbPO₄, HoYbBiIG, (Cd,Mn,Hg) Te, MnAs, Y_{2.82}Ceo_{0.18}Fe₅O₁₂, Bi-substituted iron garnet, Yttrium Iron Garnet, Terbium Gallium Garnet, Lithium Niobate, and paramagnetic rare-earth ions containing at least on nanoparticles chosen from Tb⁺³, y⁺³, and Ce⁺³.

In yet another embodiment, magnetooptic materials cited above can be used in an optical isolator that usually possesses a critical magneto-optical property, namely the Faraday effect, wherein light is allowed in the forward propagation direction of the transmission line but is blocked in the backward propagation direction. Optical isolators are critical components in the transmission line for controlling and managing destabilizing effects of backward reflected light beams. Further, such isolators are commonly realized in the form of bulky inorganic single crystals as opposed to thin films or fibers.

Several classes of materials may be used to form nanoparticles 11 depending upon the effect the nanoparticles are to have on the properties of the composite containing them. In one embodiment, nanoparticles 11 may include one or more active materials, which allow the composite to be a novel acousto-optic material. Active materials change the acousto-optic properties of the composite material. Active materials may include nanoparticles 11 made from acoustooptic materials, such as GaAs, GaP, TiO₂, SiO₂, LiNbO₃, and Y₃Al₅O₁₂(YAG).

In yet another embodiment, acousto-optic materials cited above can be used in an optical modulator that usually possesses a critical acoustooptical property, wherein light is modulated by application of a acoustic wave to the acoustooptic material. Acoustooptical modulation is used in a number of device applications, including in addition to light modulators, beam defectors, signal processors, tunable filters, and spectrum analyzers.

A dynamic gain equalizing (DGE) filter can be made consistent with the acoustooptic material of this invention. A DGE can be used to ensure that all DWDM channels in a single fiber have approximately the same power level, which, in turn, helps to lower data error rates. Unfortunately, power levels become unequal as a signal travels through fiber-optic networks due to various optical components in the network, including optical amplifiers and various environmental factors.

Several classes of materials may be used to form nanoparticles 11 depending upon the effect the nanoparticles are to have on the properties of the composite containing them. In one embodiment, nanoparticles 11 may include one or more active materials, which allow the composite to be a novel thermooptic material. Active materials change the thermooptic coefficient of the composite material. Active materials may include nanoparticles 11 made from thermooptic materials, including inorganic optical media such as the glass SiO₂, and organic optical media, such as the polymer polymethylmethacrylate (PMMA).

In yet another embodiment, thermooptic materials cited above can be used in an optical waveguide swithes that usually possesses a critical thermooptical property, wherein light is switched from one waveguide to another by application of a thermal signal to the thermoptic material. Thermooptical switches are used in a number of device applications, including in addition to light switches, add-drop multiplexers, variable optical attenuators (VOAs), tunable filters, and spectrum analyzers.

A dynamic gain equalizing (DGE) filter can be made consistent with the thermooptic material of this invention. A DGE can be used to ensure that all DWDM channels in a single fiber have approximately the same power level, which, in turn, helps to lower data error rates. Unfortunately, power levels become unequal as a signal travels through fiber-optic networks due to various optical components in the network, including optical amplifiers and various environmental factors.

In one embodiment, the nanoparticles are coated with a polymer, such as a halogenated polymer. In certain embodiments, the coated nanoparticles comprise one or more active materials.

In addition to elements of the gain medium, still other materials are useful in creating nanoparticles 11. For example, the nanoparticles, themselves, can include inorganic crystals. In an exemplary embodiment of the invention, the inorganic crystal nanoparticles include lithium niobate, lithium tantalate, indium phosphide, gallium arsenide, and other electrooptic inorganic materials. Furthermore, these inorganic crystals can combine with elements of a gain medium. These crystal-based nanoparticles can be used for electrooptic, thermooptic, and acoustooptic applications.

In addition to elements of the gain medium, still other materials are useful in creating nanoparticles 11. For example, the nanoparticles, themselves, can include inorganic materials. In an exemplary embodiment of the invention, the inorganic nanoparticles include ceramic, such as lead lanthanum zirconium titanium oxide (PLZT), and other electrooptic inorganic materials. Furthermore, these inorganic materials can combine with elements of a gain medium. These inorganic material-based nanoparticles can be used for electrooptic, thermooptic, and acoustooptic applications.

Because many semiconductor materials have refractive index values between about 2 and about 5, these materials can be used to tune the refractive index of the nanocomposite materials for optical applications, such as waveguides and microresonators. Thus, semiconductor materials may also be used to form nanoparticles 11. These materials include, for example, Si, Ge, SiGe, GaP, GaAs, InP, InAs, InSb, ZnS, PbS, PbSe, PbTe, and other semiconductor materials, as well as their counterparts doped with a rare-earth or transition metal ions. Still other materials such as inorganic salts, oxides or compounds can be used to tune the refractive index of the nanocomposite materials for optical applications, such as waveguides and microresonators. For example lithium niobate, barium titinate, proustite, yttrium aluminate, rutile, and ziroconate and other related materials, as well as their counterparts doped with a rare-earth or transition metal ions.

Still other classes of materials may be used to form nanoparticles 11 depending upon the effect the nanoparticles are to have on the properties of the nanocomposite containing them.

Metal containing materials such as metal chalocogenides (e.g., Bi₂Te₃, Bi₂Te₃), metal salts, transition metals, transition metal complexes, transition metal containing compounds, transition metal oxides, and organic dyes, such as, for example, Rodamin-B, DCM, Nile red, DR-19, and DR-1, and polymers may be used. ZnS, or PbS doped with a rare-earth or transition metal for optical amplification can also be used to form nanoparticles.

In one embodiment, the nanoparticles are coated with a long chain alkyl group, long chain ether group, or polymer, such as a halogenated long chain alkyl group, halogenated long chain ether group, or halogenated polymer.

In optical waveguide applications, the major dimension of the nanoparticles described herein is smaller than the wavelength of light used. Therefore, light impinging upon nanoparticles 11 will not interact with, or scatter from, the nanoparticles. As a result, the presence of nanoparticles 11 dispersed within the host matrix material 10 has little or no effect on light transmitted through the host matrix. Even in the presence of nanoparticles 11, the low absorption loss of host matrix 10 may be maintained.

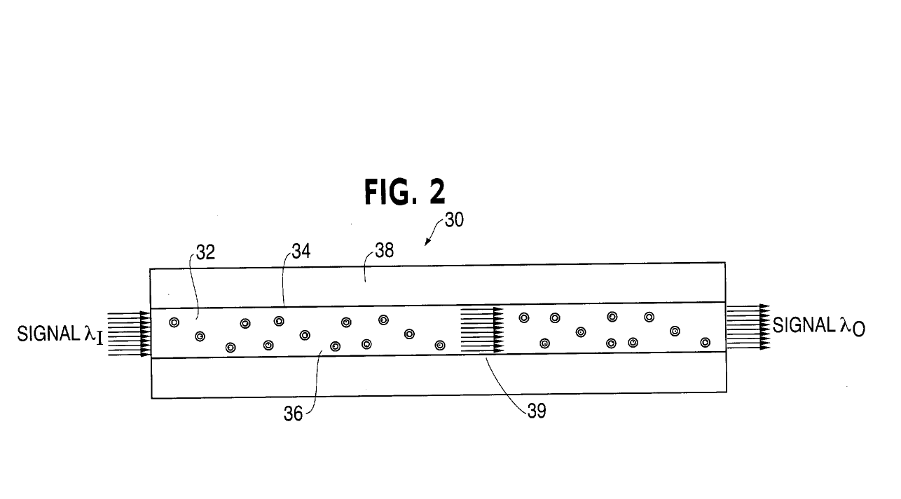

FIG. 2 shows a schematic cross-sectional view of a planar optical waveguide 30 formed using the nanoparticles according to the present invention. A cladding 38 surrounds a core 32 comprised of a host matrix 34 containing the coated nanoparticles 36. In one embodiment, the cladding 38 has a lower index of refraction than core 32. In this embodiment, the nanoparticles added to core 32 increase the index of refraction of the material comprising core 32.

In such an embodiment, input light λ_{I} is injected into the waveguide 30 at one end. The input light λ_{I} is confined within the core 32 as it propagates through core 32. The small size of the nanoparticles allows the input light λ_{I} to propagate without being scattered, which would contribute to optical power loss. Input light λ_{I} interacting with the nanoparticles 36, thus, amplifying the light signal shown schematically at 39.

Another embodiment according to the present invention comprises an optical integrated amplification device.

In another embodiment a direction wavelength divisional multiplexer (WDM) coupler 46 is placed on a waveguide chip 47 to combine a signal light λ_{S} 48 and a pump light λ_{P} 49. The pump light λ_{P} 49 stimulates the active material included in the doped nanoparticles in the core to amplify the signal light λ_{S} 48.

When the nanoparticles in the core comprise one or more of the active materials, a wavelength of the signal light is a broadband signal ranging from about 0.8 μm to about 0.9 μm, and further from about 1.2 μm to about 1.7 μm is amplified.

When the nanoparticles in the core comprise at least one material chosen from Dy, Nd, and Pr, a wavelength of the signal light ranging from about 1.27 μm to about 1.36 μm, and further, from about 1.30 μm to about 1.32 μm is amplified.

When the nanoparticles in the core comprise at least one Er comprising material, a wavelength of the signal light ranging from about 1.5 μm to about 1.6 μm, further from about 1.57 μm to about 1.61 μm, and further about 1.55 μm is amplified. In a further embodiment, the nanoparticles in the core may comprise one or more active materials. The index of refraction of the core and/or cladding may be adjusted to a desired value with the inclusion of nanoparticles.

Generally, the index of refraction of a composite that includes nanoparticles of appropriate compositions can be adjusted to different selected values. For example, adding nanoparticles disclosed herein to the host matrix will tune the refractive index of the composite to be from 1 to about 5. As a result, the nanocomposite material is suitable for use in various optical applications such as waveguides according to the present invention. The index of refraction for the nanoparticles may be determined using techniques known to one of ordinary skill in the art. For example, one can use a refractometer, elipsometer, or index matching fluid to determine the refractive index of the particles either as a film or as powders. For the measurement of nanoparticles powder samples, one can use the index matching fluid to determine the refractive index of the material. Typically, a drop of index matching fluid or immersion oil is placed onto a glass slide. A small amount of powder sample can then be mixed into the fluid droplet. The slide can then be viewed using a transmission optical microscope. The microscope is equipped with a sodium D line filter to ensure that the refractive index is being measured at a wavelength of 588 nm. The boundary between the index matching fluid and the powder can be seen when the index of the fluid and the sample is not matched. The same procedure should be repeated, using immersion oils with successively higher indices of refraction, until the boundary line can no longer be seen. At this point, the index of the immersion oil matches that of the powder.

In one embodiment, there is a halogenated polymer host matrix having a refractive index, ηₘₐₜᵣᵢₓ and a plurality of nanoparticles dispersed within the halogenated polymer host matrix having a refractive index η_{particle}. In this embodiment, the halogenated polymer host matrix and the plurality of nanoparticles form a composite having a refractive index, η_{comp}, where ηₘₐₜᵣᵢₓ is not equal to η_{particle}. Further, the nanoparticles within the halogenated polymer host matrix are in such an amount sufficient to result in a value for η_{comp} which is different from ηₘₐₜᵣᵢₓ.

In another embodiment, a nanocomposite material can be fabricated that has a high index of refraction and low absorption loss, for example less than approximately 2.5×10⁻⁴ dB/cm in the range from about 1.2 μm to about 1.7 μm. As previously stated, halogenated polymers, including fluorinated polymers, exhibit very little absorption loss (see Table 1).

TABLE 1
WAVELENGTHS AND INTENSITIES OF SOME IMPORTANT
VIBRATIONAL OVERTONES

| Bond | n | Wavelength (nm) | Intensity (relative) |
|---|---|---|---|
| C—H | 1 | 3390 | 1 |
| C—H | 2 | 1729 | 7.2 × 10⁻² |
| C—H | 3 | 1176 | 6.8 × 10⁻³ |
| C—F | 5 | 1626 | 6.4 × 10⁻⁶ |
| C—F | 6 | 1361 | 1.9 × 10⁻⁷ |
| C—F | 7 | 1171 | 6.4 × 10⁻⁹ |
| C═O | 3 | 1836 | 1.2 × 10⁻² |
| C═O | 4 | 1382 | 4.3 × 10⁻⁴ |
| C═O | 5 | 1113 | 1.8 × 10⁻⁵ |
| O—H | 2 | 1438 | 7.2 × 10⁻² |

Therefore, these halogenated polymers may be particularly suitable for transmitting light in optical waveguides and other applications according to the present invention. In such applications, nanoparticles 11 are smaller than the wavelength of incident light. Therefore, light impinging upon nanoparticles 11 will not interact with, or scatter from, the nanoparticles. As a result, the presence of nanoparticles 11 dispersed within the host matrix material 10 has little or no effect on the optical clarity of the composite, even if the nanoparticles themselves comprise material, which in bulk form would not be optically clear, or even translucent. Thus, even in the presence of nanoparticles 11, the low absorption loss of host matrix 10 may be maintained.

By contrast, the presence of nanoparticles 11 within the host matrix material 10 may contribute to significantly different properties as compared to the host matrix material alone. For example, as already noted, nanoparticles 11 may be made from various semiconductor materials, which may have index of refraction values ranging from about 1 to about 5. Upon dispersion of nanoparticles 11 into the host matrix material 10, the resulting composite material will have an index of refraction value somewhere between the index of refraction of the host matrix material 10 (usually less than about 2) and the index of refraction of the nanoparticle material. The resulting, overall index of refraction of the composite material will depend on the concentration and make-up of nanoparticles 11 within the host matrix material 10. For example, as the concentration of nanoparticles 11 in the host matrix material 10 increases, the overall index of refraction may shift closer to the index of refraction of the nanoparticles 11. The value of η_{comp} can differ from the value of ηₘₐₜᵣᵢₓ by a range of about 0.2% to about 330%. In an exemplary embodiment, the ratio of η_{particle}:ηₘₐₜᵣᵢₓ is at least 3:2. In another exemplary embodiment, the ratio of η_{particle}:ηₘₐₜᵣᵢₓ is at least 2:1.

The nanoparticle containing composites as described herein, may be employed, for example, in various applications including, but not limited to, optical devices, windowpanes, mirrors, mirror panels, optical lenses, optical lens arrays, optical displays, liquid crystal displays, cathode ray tubes, optical filters, optical components, all these more generally referred to as components.

The nanoparticle containing composites as described herein, may be also be used for example, in optical fibers, including single mode or multimode, which can be step-indexed or graded-indexed, waveguides, films, amplifiers, lasers, multiplexers, demultiplexers, isolators, interleavers, dumultiplexers, couplers, optical splitters, filters, highly-sensitive photodetectors, electro-optic and thermo-optic switches, optical micro-ring resonators, light emitting diodes, and photonic bandgap devices. Other uses include, optical anti-reflection coatings, Fabry-Perot filters made from multiplayer coatings, graded-index optical lenses, bulk-lenses, prisms, waveplates, mirrors, diffraction gratings, and light-guides. In other embodiments, the composite containing nanoparticles (“nanocomposite”) can be used in CD-ROMs and DVDs made from polymer nanocomposites. In addition, nanocomposites can be used in local area communication networks, or communications networks in a vehicle or an aircraft made with polymer nanocomposite optical fibers and components in various applications including lasers and broadband optical amplifiers.

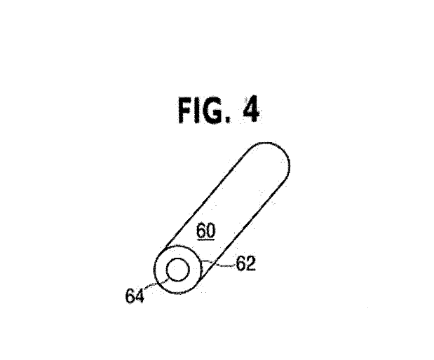

FIG. 4A schematically illustrates an optical waveguide 50 according to one embodiment of the present invention. Optical waveguide 50 includes a generally planar substrate 51, a core material 54 for transmitting incident light and a cladding material 52 disposed on the substrate 51, which surrounds the core 54 and promotes total internal reflection of the incident light within the core material 54. The core 54 of the optical waveguide may be formed of a nanocomposite as illustrated, for example, in FIG. 1.

The cladding 51 and 52 may be each independently composed of an optical polymer, such as a perfluorinated polymer. The waveguide core 54 may be composed of a nanocomposite material for example doped glass, single crystal, or polymer particles with dimensions ranging from about 1 nm to about 100 nm are embedded in a polymer waveguide core.

In such an embodiment, the core 54 may include a host matrix and a plurality of nanoparticles dispersed within the host matrix. A majority of the plurality of nanoparticles present in core 54 may further include a halogenated outer coating layer. The cladding material in certain embodiments may comprise a halogenated polymer host matrix. In certain embodiments, the cladding material may further include nanoparticles dispersed in a host matrix in such a way that the relative properties of the core and cladding can be adjusted to predetermined values.

Further, in one embodiment of the present invention, the host matrix material of the core 54 and/or cladding layer 52 includes fluorine. The nanoparticles in the optical waveguide 50 may have an index of refraction of ranging from about 1 to about 5. By selecting a particular material having a particular index of refraction value, the index of refraction of the core 54 and/or cladding layer 52 of the optical waveguide 50 may be adjusted to a predetermined desired value or to different predetermined values.

The thermo-optic properties of the host matrix may be improved by including an effective amount of nanoparticles comprising different coefficient of thermal expansion. Many materials expand when heated, and contract when cooled. The coefficient of thermal expansion (CTE) is the ratio of the change in length (due to expansion or contraction) per unit temperature. For example, materials that expand when heated are said to have a positive CTE. Conversely, materials that contract when heated exhibit a negative CTE.

A mismatch between the CTE's of the materials comprising the composite can have a degrading effect on the composite materials. Both nanoparticles and polymer matrices have a CTE. Thermal expansion and contraction can lead to degradation of the mismatched CTE's composite materials comprising the nanoparticles. For example, when two materials, such as two different polymer matrices, each having different positive CTE's are adjacent to each other, stress can occur between the materials due to the differing expansion rates.

Nanoparticles comprising materials having different CTE's can be used to adjust the CTE of a composite comprising the nanoparticles. In certain embodiments, nanoparticles comprised of materials having a negative CTE can be used in combination with nanoparticles comprised of materials having a positive CTE to adjust the CTE of the composite containing the nanoparticles.

The nanoparticles 11 may comprise materials having positive or negative thermal expansion coefficients. When nanoparticles having negative CTE's are combined with a matrix material and/or nanoparticles having positive CTE's, the resulting composite material will have a CTE between that of the negative CTE material and that of the positive CTE material. The negative CTE material need not be sized with the scale of nanoparticles. It may be sized larger than the scale of nanoparticles. In one embodiment, the CTE of the composite may therefore be controlled by choosing materials for the host matrix and/or nanoparticles having different relative CTE, and by varying the amounts of these materials within the host matrix.

The amount and type of materials comprising the nanocomposite may be chosen so that the nanocomposite exhibits little or no expansion or contraction (in other words, a CTE that is substantially zero) when cycled through various thermal environments. Alternatively, the host matrix material and the nanoparticles may be chosen to provide a composite having a specific positive or negative CTE.

Among materials having negative CTE's, examples include Ni—Ti alloys, ZrW₂O₈, ZrMo₂O₈, Y₂(WO₄)₃, V doped ZrP₂O₇, ZrV₂O₇, (Zr₂O)(PO₄)₂, Th₄(PO₄)₄P₂O₇, and AOMO₄, where A=Nb or Ta, and M=P, As, or V. Nanoparticles 11 formed from these materials exhibit a negative CTE, and therefore their dimensions shrink as temperature increases. One exemplary embodiment of materials exhibiting a negative CTE are the materials corresponding to formula (I) below:

A_{1-y}⁴⁺A_{y}¹⁺A_{y}³⁺V₂₋ₓPₓO₇ (I)

where:

A⁴⁺ is chosen form Hf, Zr, ZrₐM_{b}, or HfₐM_{b} and mixtures thereof,

a+b=1.

A¹⁺ is chosen form alkali earth metals,

A³⁺ is chosen form rare-earth metals,

M is chosen form Ti, Ce, Th, U, Mo, Pt, Pb, Sn, Ge or Si

y ranges from about 0 to about 0.4,

x ranges from about 0.6 to about 1.4,

Among the materials falling within formula (I), examples include (ZrO)₂VP₂O₇, ZrVPO₇, Zr_{0.8}Li_{0.2}Y_{0.2}VPO₇, Zr_{0.8}Ce_{0.2}VPO₇, and HfVPO₇.

In one embodiment for controlling the CTE of the composite material, the amount of nanoparticles may range from approximately 10% to about 95% by volume of the composite material. These particles may comprise particles chosen to have a negative CTE. In another embodiment, one or more of the particles are chosen to have a negative CTE, and the remaining particles have a positive CTE. In yet another embodiment, the negative CTE material comprises particles that are larger than nanoparticle-sized, and ranging from about 5% to about 99% by volume of the composite material.

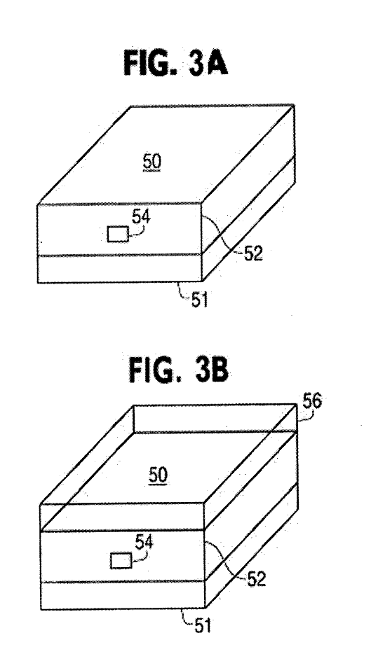

As show in FIG. 3B, optical waveguide 50 may optionally include a superstrate 56 disposed on the top of cladding 52. To minimize the variation in the wavelength response of optical waveguide 50 to environmental temperature changes, the CTE of at least one of substrate 51, cladding 52, core 54, and superstrate 56 may be controlled by the inclusion of nanoparticles. Specifically, at least one of substrate 51, cladding 52, core 54, and superstrate 56 includes a host matrix and a plurality of nanoparticles dispersed within the host matrix. By selecting a particular nanoparticle material having a particular CTE and an effective amount of the particular nanoparticles, the overall CTE of substrate 51, cladding 52, core 54, and superstrate 56 of optical waveguide 50 may be adjusted to a desired value. The plurality of nanoparticles may include a halogenated outer coating layer. Further, in one embodiment of the present invention, the host matrix material of at least one of substrate 51, cladding 52, core 54, and superstrate 56 includes fluorine.

FIG. 4 illustrates an optical waveguide 60 according to another embodiment of the present invention. Optical waveguide 60 comprises an optical fiber with a core 64 surrounded by a cladding 62. The core includes a host matrix and a plurality of nanoparticles dispersed within the host matrix. In one embodiment, core 64 comprises nanoparticles. The cladding material in this embodiment comprises a host matrix. In certain embodiments, the cladding material may also comprise nanoparticles dispersed in a host matrix. Further, in one embodiment of the present invention, the host matrix material of the core 64 and/or cladding layer 62 includes fluorine. The plurality of nanoparticles in the optical waveguide 60 may have an index of refraction ranging from about 1 to about 5. By selecting a particular material having a particular index of refraction value, the overall index of refraction of the core 64 of the optical waveguide 60 may be adjusted to a predetermined desired value or to different predetermined values.

In addition to the materials mentioned, still other materials are useful as nanoparticles 11. For example, the nanoparticles, themselves, may comprise a polymer. In an exemplary embodiment of the invention, the polymer nanoparticles comprise polymers that contain functional groups that can bind ions, such as rare-earth ions. Such polymers include homopolymers or copolymers of vinyl, acrylic, vinyl aromatic, vinyl esters, alpha beta unsaturated acid esters, unsaturated carboxylic acid esters, vinyl chloride, vinylidene chloride, and diene monomers. The reactive groups of these polymers may comprise any of the following: POOH, POSH, PSSH, OH, SO₃H, SO₃R, SO₄R, COOH, NH₂, NHR, NR₂, CONH₂, NH—NH₂, and others, where R may be chosen from linear or branched hydrocarbon-based chains, possibly forming at least one carbon-based ring, being saturated and unsaturated, aryl, alkyl, alkylene, siloxane, silane, ether, polyether, thioeter, silylene, and silazane.

The polymers for use as nanoparticles may alternatively comprise main chain polymers containing rare-earth ions in the polymer backbone, or side chain or cross-linked polymers containing the above-mentioned functional groups. The polymers may be highly halogenated yet immscible with the host matrix polymer. For example, nanoparticles of inorganic polymer, prepared by reacting erbium chloride with perfluorodioctylphosphinic acid, exhibit high crystallinity and are immscible with poly[2,3-(perfluoroalkenyl)perfluorotetrahydrofuran]. Blending these nanoparticles with the fluorinated polymer host will lead to a nanocomposite. Additionally, the nanoparticles may comprise organic dye molecules, ionic forms of these dye molecules, or polymers containing these dye molecules in the main chain or side chain, or cross-linked polymers. When the nanoparticles comprise polymers that are not halogenated, they may be optionally coated with a halogenated coating as described herein.

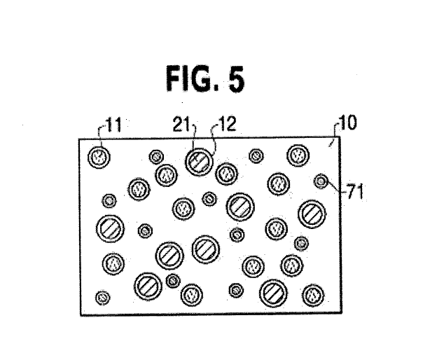

Composite materials comprising the amplifiers of the present invention may contain different types of nanoparticles. For example, FIG. 5 illustrates an exemplary embodiment of the present invention in which several groups of nanoparticles 11, 21, and 71 are present within halogenated matrix 10. Each group of nanoparticles 11, 21, and 71 is comprised of a different material surrounded by an outer layer (for example, layer 12 on particle 21).

Nanocomposites fabricated from several different nanoparticles may offer properties derived from the different nanoparticles. For example, nanoparticles 11, 21, and 71 may provide a range of different optical, structural, or other properties. Such an arrangement may be useful, for example to form broadband optical amplifiers and other optical devices according to the present invention. One skilled in the art will recognize that the present invention is not limited to a particular number of different types of nanoparticles dispersed within the host matrix material. Rather, any number of different types of nanoparticles may be useful in various applications. For example, nanocomposite Er or Er/Yb doped waveguide amplifier with waveguide core constructed of multiple types of nano-particles may be made according to the present invention. In other embodiments, nanoparticles of Er doped alumino-germano-silicate glass, Er doped phosphate glass, and Er doped inorganic single crystal may be made according to the present invention. In certain embodiments, It is also possible to include multiple types of nanoparticles doped with multiple types of rare-earth ions such as Er, thulium, dysprosium, neodymium, etc into a single polymer waveguide core to achieve broader band amplification with each rare-earth ion species amplifying a sub-band within the amplifier gain bandwidth.

Depending on the end use, the nanoparticles according to the present invention may be bare, or contain at least one outer layer. As shown in FIG. 1, the nanoparticles may include an outer layer 12. The layer 12 may serve several important functions. It may be used to protect nanoparticle 11 from moisture or other potentially detrimental substances. Additionally, layer 12 may also prevent agglomeration. Agglomeration is a problem when making composite materials that include nanoparticles distributed within a matrix material.

In one embodiment, by selecting a layer 12 of a material that is compatible with a given host matrix material, layer 12 may eliminate the interfacial energy between the nanoparticle surfaces and host matrix 10. As a result, the nanoparticles in the composite material do not tend to agglomerate to minimize the interfacial surface area/surface energy that would exist between uncoated nanoparticles and host matrix material 10. Layer 12, therefore, enables dispersion of nanoparticles 11 into host matrix material 10 without agglomeration of the nanoparticles.

When the outer layer 12 is halogenated, it may comprise at least one halogen chosen from fluorine, chlorine, and bromine. In an exemplary embodiment of the present invention, the halogenated outer layer 12 may include, for example, halogenated polyphosphates, halogenated phosphates, halogenated phosphinates, halogenated thiophosphinates, halogenated dithiophosphinates, halogenated pyrophosphates, halogenated alkyl titanates, halogenated alkyl zirconates, halogenated silanes, halogenated alcohols, halogenated amines, halogenated carboxylates, halogenated amides, halogenated sulfates, halogenated esters, halogenated acid chloride, halogenated acetylacetonate, halogenated disulfide, halogenated thiols, and halogenated alkylcyanide. While fluorine analogs of these materials can be used, analogs of these materials incorporating halogens other than fluorine, as well as hydrogen, may also be employed in outer layer 12.

In addition to protecting the nanoparticles 11 and suppressing agglomeration, layer 12 may also be designed to interact with the surfaces of nanoparticles 11. For example, halogenated outer layer 12 may comprise a material, such as one of the above listed layers, which reacts with and neutralizes an undesirable radical group, for example OH or esters, that may be found on the surfaces of nanoparticles 11. In this way, layer 12 may prevent the undesirable radical from reacting with host matrix 10. Coating 82 may also prevent fluorescence quenching in the case of fluorescence nanoparticles.

Coatings on nanoparticles 11 are not limited to a single layer, such as halogenated outer coating layer 12 shown in FIG. 1. Nanoparticles may be coated with a plurality of layers.

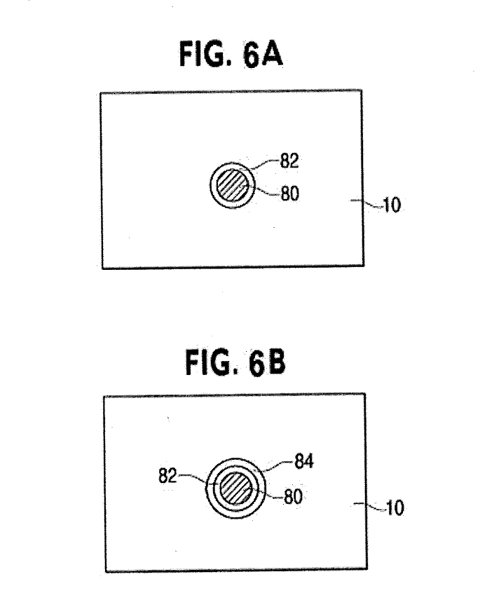

FIG. 6 schematically depicts one nanoparticle suspended within host matrix material 10. As shown, inner layer 84 is disposed between nanoparticle 80 and halogenated outer layer 82. In certain situations the interaction between a particular nanoparticle material 80 and a particular halogenated outer layer 84 may be unknown. In these situations, nanoparticles 80 may be coated with an inner coating layer 84 comprising a material that interacts with one or both of the nanoparticle material and the halogenated outer coating layer material in a known way to create a passivation layer. Such an inner coating layer may prevent, for example, delamination of the halogenated outer coating layer 82 from nanoparticle 80. While inner coating layer 84 is shown in FIG. 6 as a single layer, inner coating layer 84 may include multiple layers of similar or different materials.

FIG. 7 is a flowchart diagram representing process steps for forming a composite material according to an exemplary embodiment of the present invention. Nanoparticles 11, as shown in FIG. 1 are formed during step 101. Once formed, nanoparticles 11 are coated with a outer coating layer 12 at step 103. Optionally, at step 102, an inner coating layer 84 (or passivation layer), as shown in FIG. 7, may be formed on the nanoparticles 80. Inner coating layer 84, which may include one or more passivation layers, may be formed prior to formation of outer coating layer 82 using methods similar to those for forming outer coating layer 82.

Nanoparticles may be coated in several ways. For example, nanoparticles may be coated in situ, or, in other words, during the formation process. The nanoparticles may be formed (for example by electro-spray) in the presence of a coating material. In this way, once nanoparticles 11 have dried to form an aerosol, they may already include layer 12 of the desired host material.

In one embodiment, layer 12 may be formed by placing the nanoparticles into direct contact with the coating material. For example, nanoparticles may be dispersed into a solution including a halogenated coating material. In some embodiments, nanoparticles may include a residual coating left over from the formation process. In these instances, nanoparticles may be placed into a solvent including constituents for forming the outer coating layer. Once in the solvent, a chemical replacement reaction may be performed to substitute outer coating layer 12 for the preexisting coating on the plurality of nanoparticles 11. In one embodiment, nanoparticles may be coated with a coating in a gas phase reaction, for example, in a gas phase reaction of hexamethyldisilazane.

In another embodiment, the nanoparticles may be dispersed by co-dissolving them, and the host matrix, in a solvent (forming a solution), spin coating the solution onto a substrate, and evaporating the solvent from the solution.

In another embodiment, the nanoparticles may be dispersed in a monomer matrix, which is polymerized after the dispersion. For example, metal oxide nanoparticles can be dispersed into a liquid monomer under sonication. The resulting mixture is then degassed and mixed with either a thermal intiator or a photo-initiator, such as azo, peracid, peroxide, or redox type intiators. The mixture is then heated to induce polymerization forming a polymer nanocomposite. Additionally, the pre-polymerized mixture can be spin-coated onto a substrate followed by thermally or photo-induced polymerization to form a nanocomposite thin film.

In yet another embodiment, coatings may be in the form of a halogenated monomer. Once the monomers are absorbed on the surface of the particles, they can be polymerized or cross-linked. Additionally, coatings in the form of polymers can be made by subjecting the particles, under plasma, in the presence of halogenated monomers, to form coated nanoparticles with plasma induced polymerization of the particle surface. The coating techniques described are not intended to be an exhaustive list. Indeed, other coating techniques known to one of ordinary skill in the art may be used.

Once nanoparticles have been formed and optionally coated, they are dispersed into host matrix at step 104 to obtain a uniform distribution of nanoparticles within host matrix, a high shear mixer, or a sonicator may be used. Such high shear mixers may include, for example, a homogenizer or a jet mixer.

Another method of dispersing nanoparticles throughout the host matrix is to co-dissolve the nanoparticles with a polymer in a suitable solvent, spin-coating the solution onto a substrate, and then evaporating the solvent to form a polymer nanocomposite film.

Yet another method of dispersing nanoparticles throughout the host matrix is to disperse nanoparticles into a monomer, and then polymerize the monomer to form a nanocomposite. The monomer can be chosen from the group comprising acrylate, methacrylate, styrene, vinyl carbozole, halogenated methacrylate, halogenated acrylate, halogenated styrene, halogenated substituted styrene, trifluorovinyl ether monomer, epoxy monomer with a cross-linking agent, and anhydride/diamine, although those skilled in the art will recognize that other monomers can be used as well. The dispersion techniques described are not intended to be an exhaustive list. Indeed, other dispersion techniques known to one of ordinary skill in the art can be used.

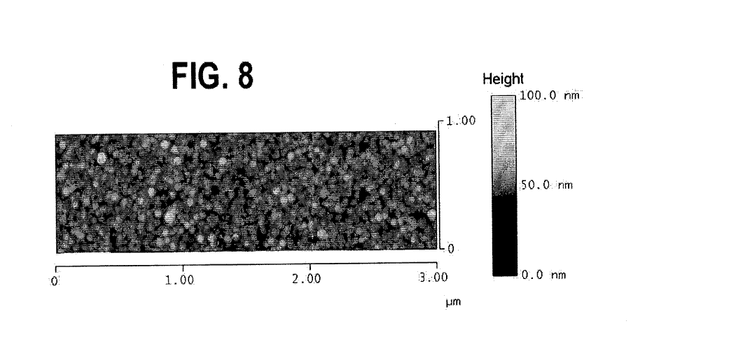

In one embodiment of the present invention, the host matrix may comprise various types of nanoparticles. For example, in certain embodiments the host matrix may comprise particles and/or nanoparticles having positive and/or negative CTE. In other embodiments the index of refraction of the host matrix can be adjusted by including a single type, or various types, of nanoparticles where the nanoparticles comprise an index of refraction. The host matrix may also comprise nanoparticles comprising active materials. In addition, in certain embodiments, the host matrix may comprise nanoparticles comprising sulfides. Embodiments of the present invention also include matrices comprising particles and/or nanoparticles comprising positive and/or negative CTE, and/or various nanoparticles comprising various indexes of refraction, and/or active materials, and/or sulfides. In certain embodiments the nanoparticles comprise coatings, while in other embodiments, the nanoparticles have no coating. FIG.8 shows the AFM image of an exemplary nanoparticles with particle size of less then 50 nm. In addition, in certain embodiments, the matrices may be halogenated or non-halogenated. Thus, different combinations are explicitly considered.

In one embodiment of the present invention, the host matrix may comprise various types of nanoparticles. For example, in certain embodiments the host matrix may comprise particles and/or nanoparticles having positive and/or negative CTE. In other embodiments the index of refraction of the host matrix can be adjusted by including a single type, or various types, of nanoparticles where the nanoparticles comprise an index of refraction. The host matrix may also comprise nanoparticles comprising active materials. In addition, in certain embodiments, the host matrix may comprise nanoparticles comprising sulfides. Embodiments of the present invention also include matrices comprising particles and/or nanoparticles comprising positive and/or negative CTE, and/or various nanoparticles comprising various indexes of refraction, and/or active materials, and/or sulfides. In certain embodiments the nanoparticles comprise coatings, while in other embodiments, the nanoparticles have no coating. In addition, in certain embodiments, the matrices may be halogenated or non-halogenated. Thus, different combinations are explicitly considered.

In another embodiment, the polymer nanocomposites comprising a host matrix and nanoparticles of various functionalities may further offer improvement in abrasion resistance properties. When fluoropolymers are doped with hard, inorganic materials such as SiO₂, TiO₂, YAG, etc, the polymer abrasion properties are enhanced by the presence of the inorganic components. These types of polymer composites offer additional advantages such as thermal and chemical stability, improved weatherability, and low water absorption when compared with conventional hydrocarbon based composites. For a typical hydrocarbon polymer matrix, such as poly(methyl methacrylate), the water absorption is 0.3% for 60° C. water immersion test. On the other hand, a perfluorinated polymer under the same test condition has less then 0.01% water absorption.

In yet another embodiment, the polymer nanocomposites comprising a host matrix and nanoparticles of various functionalities may further offer improvement in antireflective coatings. The inventive materials are designed optical polymer nanocomposites, generally comprised of an amorphous polymer material that exhibit high optical transparency over the three color fields and that acts at the same time as a host matrix for incorporating one, or more, coated inorganic, organic, or polymer nanoparticles with one, or more, particles incorporating a selected rare-earth ion in the wavelength regions of the three principal maxima of the optic cells, namely 450 nm, 525 nm, and 575 nm.

Examples of the rare-earth metals include the lanthanide series, elements Z=58 to Z=71 and their corresponding ions, Er, Dy,Nd, Pr, Yb, and Holmium. Thus, for example, it is found that suitable nanoparticles, with some or all possessing suitable optical absorption characteristics, can be introduced into the host matrix polymer composition ranging from about 0.1 to about 100 parts by weight of polymer. The light absorption performance of the optical polymer nanocomposite can be controlled by adjusting the concentrations and relative ratios of each of the rare-earth ions incorporated in the nanocomposite material. Consequently, the inventive materials have excellent anti-glare and transparency properties while appearing with little, or no, color due to the relatively low coloring coming from the adjusted rare-earth ions.

The composite materials of the present invention such as the fluoropolymers doped with nanoparticles and nanoparticles coated with fluorocarbon coatings offer advantages such as improved thermal stability, chemical resistance, low water absorptivity, and biocompatibility. These properties could provide improvements in applications such as (1) Gas Sensing: when the nanoparticles comprise ZnO, SnO₂, WO₃, TiO₂, Fe₂O₃, BiFeO₃, MgAl₂O₄, SrTiO₃, or Sr_{1-y}Ca_{y}FeO₃₋ₓ; (2) when the nanoparticles comprise metallic particles such as CoPt, FePt, iron oxides; and (3) Drug Delivery: when nanoparticles comprise fluorocoated Au particles.

What is claimed is:

1. A composite material comprising:
a host matrix, and
a plurality of nanoparticles within the host matrix.

2. The composite material of claim 1, wherein a majority of said nanoparticles includes at least one coating.

3. The composite material of claim 2, wherein a majority of said nanoparticles includes a halogen-containing outer layer.

4. The composite material of claim 1, wherein said host matrix comprises at least one polymer.

5. The composite material of claim 1, wherein the plurality of nanoparticles is distributed within said host matrix such that the composite exhibits substantially isotropic properties.

6. The composite material of claim 1, wherein said host matrix is chosen from halogenated elastomers, perhalogenated elastomers, halogenated plastics, and perhalogenated plastics.

7. The composite material of claim 1, wherein said host matrix comprises a polymer, a copolymer, or a terpolymer having at least one halogenated monomer chosen from one of the following formulas: 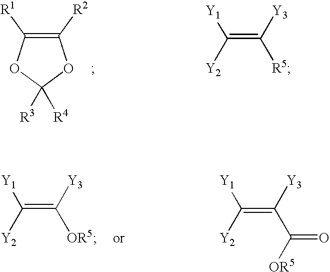
wherein;
R¹, R², R³, R⁴, and R⁵, which may be identical or different, are each chosen from linear or branched hydrocarbon-based chains, capable of forming at least one carbon-based ring, being saturated or unsaturated, wherein at least one hydrogen atom of the hydrocarbon-based chains may be halogenated; a halogenated alkyl, a halogenated aryl, a halogenated cyclic alky, a halogenated alkenyl, a halogenated alkylene ether, a halogenated siloxane, a halogenated ether, a halogenated polyether, a halogenated thioether, a halogenated silylene, and a halogenated silazane;
Y₁ and Y₂, which may be identical or different, are chosen from H, F, Cl, and Br atoms; and
Y₃ is chosen from H, F, Cl, and Br atoms, CF₃, and CH₃.

8. The composite material of claim 7, wherein R¹, R², R³, R⁴, and R⁵ are at least partially fluorinated.

9. The composite material of claim 7, wherein R¹, R², R³, R⁴, and R⁵ are completely fluorinated.

10. The composite material of claim 7, wherein at least one of R¹, R², R³, R⁴, and R⁵ is chosen from a C₁-C₁₀, linear or branched, being saturated or unsaturated hydrocarbon-based chains.

11. The composite material of claim 1, wherein said host matrix comprises a polymer condensation product of at least one of the following monomeric reactions:
HO—R—OH+NCO—R′—NCO; or
HO—R—OH+Ary¹-Ary²,
wherein;
R, R′, which may be identical or different, are chosen from one of halogenated alkylenes, halogenated siloxanes, halogenated ethers, halogenated silylenes, halogenated arylenes, halogenated polyethers, and halogenated cyclic alkylenes; and
Ary¹, Ary², which may be identical or different, are chosen from halogenated aryls and halogenated alkyl aryls.

12. The composite material of claim 1, wherein said host matrix comprises a material chosen from halogenated polycarbonates, halogenated cyclic olefin polymers, halogenated cyclic olefin copolymers, halogenated polycyclic polymers, halogenated polyimides, halogenated polyether ether ketones, halogenated epoxy resins, and halogenated polysulfones.

13. The composite material of claim 1, wherein said host matrix comprises a combination of two or more different fluoropolymer materials.

14. The composite material of claim 1, wherein said polymer host matrix further comprises halogenated polymers having functional groups chosen from phosphinates, phosphates, carboxylates, silanes, siloxanes, and sulfides.

15. The composite material of claim 14, wherein the functional groups chosen from POOH, POSH, PSSH, OH, SO₃H, SO₃R, SO₄R, COOH, NH₂, NHR, NR₂, CONH₂, and NH—NH₂, wherein R denotes: linear or branched hydrocarbon-based chains, capable of forming at least one carbon-based ring, being saturated or unsaturated; alkylenes, siloxanes, silanes, ethers, polyethers, thioethers, silylenes, and silazanes.

16. The composite material of claim 1, wherein at least one material comprising said host matrix is chosen from homopolymers, or copolymers, of vinyl, acrylate, methacrylate, vinyl aromatic, vinyl ester, alpha beta unsaturated acid ester, unsaturated carboxylic acid ester, vinyl chloride, vinylidene chloride, and diene monomers.

17. The composite material of claim 1, wherein said host matrix comprises a hydrogen-containing fluoroelastomer.

18. The composite material of claim 1, wherein said host matrix further comprises a cross-linked halogenated polymer.

19. The composite material of claim 18, wherein said halogenated polymer comprises a fluorinated polymer.

20. The composite material of claim 1, wherein said polymer comprises a perhalogenated polymer.

21. The composite material of claim 20, wherein the perhalogenated polymer comprises a perfluorinated polymer.

22. The composite material of claim 20, wherein said polymer comprises a perhalogenated elastomer.

23. The composite material of claim 1, wherein said host matrix comprises a hydrogen-containing perfluoroelastomer.

24. The composite material of claim 1, wherein said host matrix comprises a hydrogen-containing fluoroplastic.

25. The composite material of claim 1, wherein said host matrix comprises a hydrogen-containing perfluorothermoplastic.

26. The composite material of claim 1, wherein said host matrix comprises a blend of at least one material chosen from halogenated, fluorinated, and perfluorinated polymer.

27. The composite material of claim 1, wherein said host matrix comprises poly[2,2-bistrifluoromethyl-4,5-difluoro-1,3-dioxole-co-tetrafluoroethylene].

28. The composite material of claim 1, wherein said polymer host matrix comprises poly[2,2-bisperfluoroalkyl-4,5-difluoro-1,3-dioxole-co-tetrafluoroethylene].

29. The composite material of claim 1, wherein said host matrix comprises poly[2,3-(perfluoroalkenyl)perfluorotetrahydrofuran].

30. The composite material of claim 1, wherein said polymer host matrix comprises poly[2,2,4-trifluoro-5-trifluoromethoxy-1,3-dioxole-co-tetrafluoroethylene].

31. The composite material of claim 1, wherein said host matrix comprises poly(pentafluorostyrene).

32. The composite material of claim 1, wherein said host matrix comprises fluorinated polyimide.

33. The composite material of claim 1, wherein said host matrix comprises fluorinated polymethylmethacrylate.

34. The composite material of claim 1, wherein said host matrix comprises polyfluoroacrylates.

35. The composite material of claim 1, wherein said host matrix comprises polyfluorostyrene.

36. The composite material of claim 1, wherein said host matrix comprises fluorinated polycarbonates.

37. The composite material of claim 1, wherein said host matrix comprises perfluoro-polycyclic polymers.

38. The composite material of claim 1, wherein said polymer host matrix comprises fluorinated cyclic olefin polymers.

39. The composite material of claim 1, wherein said host matrix comprises fluorinated copolymers of cyclic olefins.

40. The composite material of claim 1, wherein said plurality of nanoparticles comprises at least one element chosen from rare-earth metals, transition metals, group V elements, V³⁺, Cr³⁺, Cr⁴⁺, Co²⁺, Fe²⁺, Ni²⁺, Ti³⁺, and Bi³⁺.

41. The composite material of claim 1, wherein said plurality of nanoparticles comprises at least one element chosen from rare-earth metals, V³⁺, Cr³⁺, Cr⁴⁺, Co²⁺, Fe²⁺, Ni²⁺, Ti³⁺, and Bi³⁺.

42. The composite material of claim 1, wherein said plurality of nanoparticles comprises at least one element chosen from transition metals, V³⁺, Cr³⁺, Cr⁴⁺, Co²⁺, Fe²⁺, Ni²⁺, Ti³⁺, and Bi³⁺.

43. The composite material of claim 1, wherein said plurality of nanoparticles comprises at least one component chosen from group V elements, V³⁺, Cr³⁺, Cr⁴⁺, Co²⁺, Fe²⁺, Ni²⁺, Ti³⁺, and Bi³⁺.

44. The composite material of claim 1, wherein said plurality of nanoparticles comprises at least one component chosen from V³⁺, Cr³⁺, Cr⁴⁺, Co²⁺, Fe²⁺, Ni²⁺, Ti³⁺, and Bi³⁺.

45. The composite material of claim 40, wherein said at least one element is combined with at least one material chosen from oxides, phosphates, halophosphates, arsenates, sulfates, borates, aluminates, gallates, silicates, germanates, vanadates, niobates, tantalates, tungstates, molybdates, alkalihalogenates, halides, nitrides, nitrates, sulfides, zirconates, selenides, sulfoselenides, oxysulfides, phosphinates, hexafluorophosphinates, and tetrafluoroborates.

46. The composite material of claim 40, wherein said at least one element is chosen form Cr³⁺ and Cr⁴⁺, and is combined with at least one material chosen from oxides, phosphates, halophosphates, arsenates, sulfates, borates, aluminates, gallates, silicates, germanates, vanadates, niobates, tantalates, tungstates, molybdates, alkalihalogenates, halides, nitrides, nitrates, sulfides, zirconates, selenides, sulfoselenides, oxysulfides, phosphinates, hexafluorophosphinates, and tetrafluoroborates.

47. The composite material of claim 1, wherein said plurality of nanoparticles comprises a semiconductor material.

48. The composite material of claim 47, wherein said plurality of nanoparticles comprises a semiconductor material chosen from Si, PbS, Ge, GaP, GaAs, InP, InAs, InSb, PbSe, and PbTe.

49. The composite material of claim 1, wherein said plurality of nanoparticles comprises at least one material chosen from group III through group V elements.

50. The composite material of claim 1, wherein said plurality of nanoparticles comprises at least one material chosen from n-type group III through group V elements.

51. The composite material of claim 1, wherein said plurality of nanoparticles comprises at least one material chosen from precious metals, Cu, and alloys thereof.

52. The composite material of claim 1, wherein said plurality of nanoparticles comprises at least one material chosen from transition metal elements, transition metal complexes, transition metal containing materials, transition metal oxides, and transition metal containing polymers.

53. The composite material of claim 1, wherein said plurality of nanoparticles comprises at least one material having an index of refraction ranging from about 1 to about 5.

54. The composite material of claim 1, wherein said plurality of nanoparticles comprises at least one material having an index of refraction ranging from about 1.5 to about 4.5.

55. The composite material of claim 1, wherein said plurality of nanoparticles comprises at least one material chosen from dye nanoparticles.

56. The composite material of claim 1, wherein said plurality of nanoparticles comprises at least one material chosen from Cr³⁺, Cr⁴⁺, and Ca₂GeO₄.

57. The composite material of claim 40, wherein said plurality of nanoparticles further comprises at least one material chosen from Si, PbS, Ge, GaP, GaAs, InP, InAs, InSb, PbSe, PbTe, lithium niobate, non-linear optical chromophores, and organic dyes.

58. The composite material of claim 1, wherein said plurality of nanoparticles comprises at least one functional group is chosen from POOH, POSH, PSSH, OH, SO₃H, SO₃R, SO₄R, COOH, NH₂, NHR, NR₂, CONH₂, and NH—NH₂, wherein R is chosen from linear or branched hydrocarbon-based chains, capable of forming at least one carbon-based ring, being saturated or unsaturated, alkylenes, siloxanes, silanes, ethers, polyethers, thioethers, silylenes, and silazanes.

59. The composite material of claim 1, wherein said plurality of nanoparticles comprises at least one polymer.

60. The composite material of claim 59, wherein said at least one polymer is chosen from homopolymers, or copolymers, of vinyl, acrylic, vinyl aromatic, vinyl esters, alpha beta unsaturated acid esters, unsaturated carboxylic acid esters, vinyl chloride, vinylidene chloride, and diene monomers.

61. The composite material of claim 1, wherein a majority of said plurality of nanoparticles has a major dimension of less than about 50 nm.

62. The composite material of claim 1, wherein said plurality of nanoparticles further comprises a first group of particles including an active material of a first type and at least one group of particles that including an active material of a type different from the first type.

63. The composite material of claim 1, wherein a majority of said nanoparticles include a halogenated outer coating layer comprising at least one halogen chosen from fluorine, chlorine, and bromine atoms.

64. The composite material of claim 63, wherein the halogenated outer coating layer is formed from at least one material chosen from halogenated polyphosphates, halogenated phosphates, halogenated phosphinates, halogenated dithiophosphinates, halogenated pyrophosphates, halogenated alkyl titanates, halogenated alkyl zirconates, halogenated silanes, halogenated alcohols, halogenated amines, halogenated carboxylates, halogenated amides, halogenated sulfates, halogenated esters, halogenated acid chloride, halogenated acetylacetonate, halogenated thiols, and halogenated alkylcyanide.

65. The composite material of claim 64, wherein the halogenated outer coating layer is fluorinated.

66. The composite material of claim 63, wherein said plurality of nanoparticles further includes an inner coating disposed beneath the halogenated outer coating layer, wherein the inner coating includes one or more passivation layers.

67. The composite material of claim 63, wherein the halogenated outer coating layer comprises a material that reacts with and neutralizes a radical group on at least one of the plurality of nanoparticles.

68. The composite material of claim 67, wherein the radical group is OH.

69. The composite material of claim 67, wherein the radical group comprises an ester.

70. A process of forming a composite material, comprising:
coating a majority of a plurality of nanoparticles with a halogenated outer layer; and
dispersing the plurality of coated nanoparticles into a host matrix material.

71. The process of claim 70, wherein the host matrix material comprises at least one polymer.

72. The process of claim 70, wherein the host matrix material comprises at least one halogen-containing polymer.

73. The process of claim 70, further comprising forming one or more passivation layers on a majority of the nanoparticles prior to coating each of the plurality of nanoparticles with a halogenated outer layer.

74. The process of claim 70, wherein coating a majority of the nanoparticles further comprises:
forming the plurality of nanoparticles in the presence of a halogen-containing coating material, and
forming the halogenated outer layer on a majority of the nanoparticles in situ.

75. The process of claim 70, wherein coating a majority of the nanoparticles further comprises dispersing nanoparticles into a solution including a halogen-containing coating material.

76. The process of claim 70, wherein coating the nanoparticles further comprises;
placing the nanoparticles into a solvent including constituents for forming the halogenated outer layer; and
performing a chemical replacement reaction to substitute the halogenated outer layer for a preexisting coating on a majority of the plurality of nanoparticles.

77. The process of claim 70, wherein dispersing comprises;
co-dissolving the nanoparticles, and the host matrix, in a solvent to form a solution;
spin coating the solution onto a substrate; and
evaporating the solvent from the solution.

78. The process of claim 70, wherein the host matrix is a monomer host matrix.

79. The process of claim 78, further comprising polymerizing the monomer after dispersing the nanoparticles in the host matrix.

80. An optical waveguide comprising:
a core for transmitting incident light; and
a cladding material disposed about the core,
wherein the core of the optical waveguide comprises:
a host matrix; and
a plurality of nanoparticles dispersed within the host matrix.

81. The optical waveguide of claim 80, wherein the plurality of nanoparticles including at least one halogenated outer coating layer.

82. The optical waveguide of claim 80, wherein the host matrix comprises at least one material chosen from halogenated elastomers, perhalogenated elastomers, halogenated plastics, and perhalogenated plastics.

83. The optical waveguide of claim 80, wherein the host matrix comprises at least one material chosen from hydrogen-containing perfluoroelastomers, hydrogen-containing fluoroplastics, perfluorothermoplastics, blend of at least two different fluoropolymer materials, poly[2,2-bistrifluoromethyl-4,5-difluoro-1,3-dioxole-co-tetrafluoroethylene], poly[2,2-bisperfluoroalkyl-4,5-difluoro-1,3-dioxole-co-tetrafluoroethylene], poly[2,3-(perfluoroalkenyl)perfluorotetrahydrofuran, poly[2,2,4-trifluoro-5-trifluoromethoxy-1,3-dioxole-co-tetrafluoroethylene], poly(pentafluorostyrene), fluorinated polyimides, fluorinated polymethylmethacrylate, polyfluoroacrylates, polyfluorostyrene, fluorinated polycarbonates, perfluoro-polycyclic polymers, fluorinated cyclic olefin polymers, and fluorinated copolymers of cyclic olefins.

84. The optical waveguide of claim 80, wherein said plurality of nanoparticles comprises at least one material chosen from rare-earth metals, V³⁺, Cr³⁺, Cr⁴⁺, Co²⁺, Fe²⁺, Ni²⁺, Ti³⁺, and Bi³⁺.

85. The optical waveguide of claim 80, wherein said at least one material is combined with at least one material chosen from oxides, phosphates, halophosphates, arsenates, sulfates, borates, aluminates, gallates, silicates, germanates, vanadates, niobates, tantalites, tungstates, molybdates, alkalihalogenates, halogenides, nitrides, sulfides, selenides, sulfoselenides, oxysulfides, phosphinates, hexafluorophosphinates, and tetrafluoroborates.

86. The optical waveguide of claim 80, wherein said at least one material is chosen from Cr³⁺ and Cr⁴⁺, and combined with at least one material chosen from oxides, phosphates, halophosphates, arsenates, sulfates, borates, aluminates, gallates, silicates, germanates, vanadates, niobates, tantalites, tungstates, molybdates, alkalihalogenates, halogenides, nitrides, sulfides, selenides, sulfoselenides, oxysulfides, phosphinates, hexafluorophosphinates, and tetrafluoroborates.

87. The optical waveguide of claim 80, wherein said plurality of nanoparticles comprises a polymer.

88. The optical waveguide of claim 80, wherein the halogenated outer coating layer comprises at least one halogen chosen from fluorine, chlorine, and bromine.

89. The optical waveguide of claim 80, wherein the halogenated outer coating layer is formed from at least one material chosen from a group comprising halogenated polyphosphates, halogenated phosphates, halogenated phosphinates, halogenated dithiophosphinates, halogenated pyrophosphates, halogenated alkyl titanates, halogenated alkyl zirconates, halogenated silanes, halogenated alcohols, halogenated amines, halogenated carboxylates, halogenated amides, halogenated sulfates, halogenated esters, halogenated acid chloride, halogenated acetylacetonate, halogenated thiols, and halogenated alkylcyanide.

90. The optical waveguide of claim 80, wherein said plurality of nanoparticles further includes at least one inner coating disposed beneath the halogenated outer layer coating layer, wherein the inner coating includes at least one passivation layer.

91. The optical waveguide of claim 80, wherein a majority of said plurality of nanoparticles has a major dimension of less than about 50 nm.

92. A process for improving a gain medium of a component, said process comprising:
a composite material further comprising:
a host matrix; and
a plurality of nanoparticles within the host matrix; and
doping said host matrix with an effective amount of particles comprising at least one material chosen from rare-earth metals, Cr³⁺, Cr⁴⁺, Ni²⁺, V³⁺, Ti³⁺, Bi³⁺, Co²⁺, and Fe²⁺.

93. A process for improving electro-optic properties of a component said process comprising:
forming said component from a composite material comprising:
a host matrix; and
a plurality of nanoparticles within the host matrix; and
doping said host matrix with nanoparticles comprising at least one material chosen from lithium niobate, GaAs, non-linear optical chromophores and organic dyes.

94. The process of claim 93, wherein at least one said organic dye is chosen from derivatives of dithiphene, diphenoquinoid, and anthraquinodimethane.

95. A process for improving magneto-optic properties of a component, said process comprising:
forming said component from a composite material comprising,
a host matrix, and
a plurality of nanoparticles within the host matrix; and
adding to said nanoparticles an effective amount of least one material chosen from YVO₄, TbPO₄, HoYbBiIG, (Cd,Mn,Hg)Te, MnAs, Y_{2.82} Ce0.18Fe₅O₁₂, Bi-substituted iron garnet, Yttrium Iron Garnet, Terbium Gallium Garnet, Lithium Niobate, and paramagnetic rare-earth ions containing at least one nanoparticle chosen from Tb⁺³, Y⁺³, and Ce⁺³.

96. The process of claim 95 wherein the concentration of the said nanoparticles ranges from about 10 volume % to about 95 volume % of the composite material.

97. A process for improving abrasion resistant properties of a component, said process comprising;
forming said component from a composite material comprising:
a host matrix;
a plurality of nanoparticles within the host matrix; and
doping said host matrix with an effective amount of at least one hard material.

98. The process of claim 97 wherein said alt least one hard material is chosen from SiO₂, TiO₂, and YAG.

99. A process for improving the light absorption properties of a component, said process comprising:
forming said component from a composite material comprising:
a host matrix;
a plurality of nanoparticles within the host matrix; and
coating said nanoparticles with an amorphous polymer material that exhibits high optical transparency.

100. The process in claim 100, wherein said amorphous polymer material comprises at least one material chosen from coated inorganic, organic, and polymer nanoparticles; further comprising at least one nanoparticles comprising a material chosen from rare-earth metals

101. The process in claim 99 wherein said rare-earth metals are chosen from Nd⁺³, Pr⁺³, and Ho⁺³.

102. The process in claim 99 wherein said nanoparticles exhibit optical absorption characteristics in approximately a 450 nm, 525 nm, or 575 nm wavelength.

103. A process for improving thermal stability properties of a component, said process comprising:
forming said component from a composite material comprising:
a host matrix;
a plurality of nanoparticles within the host matrix; and
doping said host matrix with an effective amount of nanoparticles comprising at least one material chosen from materials having a negative thermal expansion coefficient.

104. The process of claim 103, wherein said at least one material having a negative thermal expansion coefficient is chosen from Ni—Ti alloys, ZrW₂O₈, ZrMo₂O₈, Y₂(WO₄)₃, V doped ZrP₂O₇, ZrV₂O₇, (Zr₂O)(PO₄)₂, Th₄(PO₄)₄P₂O₇, and AOMO₄,
wherein;
A is chosen from Nb and Ta;
M is chosen from P, As, and V.

105. The process of claim 103, wherein said at least one material having a negative thermal expansion coefficient is chosen from materials of formula (I)
A_{1-y}⁴⁺A_{y}¹⁺A_{y}³⁺V₂₋ₓPₓO₇ (I)
wherein;
A⁴⁺ is chosen from Hf, Zr, ZrₐM_{b}, and HfₐM_{b}, and mixtures thereof,
a+b=1
A¹⁺ is chosen from alkali earth metals,
A³⁺ is chosen from rare-earth metals,
M is chosen from Ti, Ce, Th, U, Mo, Pt, Pb, Sn, Ge or Si
y ranges from about 0 to about 0.4,
x ranges from about 0.6 to about 1.4.

106. The process of claim 105, wherein said at least one material having of formula (I) is chosen from (ZrO)₂VP₂O₇, ZrVPO₇, Zr_{0.8}Li_{0.2}VPO₇, Zr_{0.8}Ce_{0.2}VPO₇, and HfVPO₇.

107. A composition comprising:
a halogen polymer host matrix; and
a plurality of nanoparticles within the halogenated polymer host matrix.

108. A process for improving chemical resistance of a component, said process comprising:
forming said component from a composite material comprising:
a halogen-containing polymer host matrix; and
a plurality of nanoparticles within the halogen-containing polymer host matrix.

109. A process for reducing water absorptivity of a component, said process comprising:
forming said component from a composite material comprising:
a halogen-containing polymer host matrix; and
a plurality of nanoparticles within the halogen-containing polymer host matrix.

110. A process for improving biocompatibility of a component, said process comprising:
forming said component from a composite material comprising:
a halogen-containing polymer host matrix; and
a plurality of nanoparticles within the halogen-containing polymer host matrix.

111. An integrated optical component comprising:
a host matrix; and
a plurality of nanoparticles within the host matrix.

112. A drug delivery device comprising:
a host matrix; and
a plurality of nanoparticles within the host matrix,
said nanoparticles comprising and effective amount of active ingredient.

113. The device of claim 112, wherein a majority of said nanoparticles are coated with an effective amount of biocompatible material.

114. An integrated component comprising:
a host matrix; and
a plurality of nanoparticles within the host matrix.
